(19) United States
(12) Patent Application Publication
(10) Pub. No.: US 2016/0294558 A1
(43) Pub. Date: Oct. 6, 2016

(54) INFORMATION COLLECTION SYSTEM AND A CONNECTION CONTROL METHOD IN THE INFORMATION COLLECTION SYSTEM

(71) Applicant: HITACHI, LTD., Tokyo (JP)

(72) Inventor: Atsushi TAGUCHI, Tokyo (JP)

(73) Assignee: HITACHI, LTD., Tokyo (JP)

(21) Appl. No.: 15/075,306

(22) Filed: Mar. 21, 2016

(30) Foreign Application Priority Data
Mar. 31, 2015 (JP) 2015-072186

(51) Int. Cl. H04L 9/32; H04L 12/66; H04L 29/08; H04L 29/06

(52) U.S. Cl. CPC H04L 9/3242; H04L 9/3263; H04L 63/06; H04L 63/0823; H04L 63/02; H04L 12/66; H04L 67/06

(57) ABSTRACT

An information collection system includes an information processing system and a gateway connected with the information processing system via a network. The information processing system includes a first server being an initial connection destination of the gateway and holding a sever certificate, a second sever being a transmission destination of measured data from the gateway, and a third server managing the first server and the second server. The third server creates a first authentication code and transmits it to the first server. The gateway creates a second authentication code and acquires the server certificate from the first server when the second authentication code matches the first authentication code.

### CLAIM OF PRIORITY

The present application claims priority from Japanese patent application JP2015-72186 filed on Mar. 31, 2015, the content of which is hereby incorporated by reference into this application.

### BACKGROUND

The subject matter discussed herein relates to a so-called M2M system, particularly, an information collection system and a connection control method in the information collection system.

In a communication system including a client and a server, a communication sequence illustrated in FIG. 15 is known as a method for the client to enter a network.

FIG. 15 depicts a representative example of a communication sequence for establishing a Transport Layer Security (TLS) cryptographic communication channel. TLS is described in RFC 5246, The Transport Layer Security (TLS) Protocol Version 1.2, pp. 26-64. The TLS cryptographic communication can prevent a communication intercept from any other device than the client and the server. The TLS cryptographic communication can prevent another client from masquerading as the client during the communication and another server from masquerading as the server during the communication.

The client transmits supported cipher suits and a random number for creating a master secret on a “ClientHello” to the server (SQ1501).

The server compares cipher suits supported by the server and the cipher suits on the “ClientHello”, and transmits a cipher suit to be used between the server and the client on a “ServerHello” to the client. A random number for creating the master secret is also contained in the “ServerHello”. The server transmits its X.509 server certificate on a “Certificate” to the client for indicating the server is the authentic server. The server transmits a “ServerHelloDone” for notifying the client of the completion of the phase of “hello” messages (SQ1502).

The client confirms the server is authentic by verifying the X.509 server certificate on the “Certificate”. The client transmits a “ClientKeyExchange” to the server. The content of the “ClientKeyExchange” depends on the public key algorism determined by the “ClientHello” and the “ServerHello”. The client transmits a “ChangeCipherSpec”. Then, the client updates the cypher specifications. Subsequently, the client transmits a “Finished” to the sever using the cypher specifications (SQ1504).

The server transmits a “ChangeCipherSpec” to the client. Then, the server updates the cypher specifications. Subsequently, the server transmits a “Finished” to the client using the cypher specifications (SQ1505). The above described TLS negotiation establishes a TLS cryptographic communication channel between the client and the server.

Typically, Internet Key Exchange (IKE) is used between a client and a server as a necessary framework for establishing an IPsec cryptographic communication channel. IKE is, for example, disclosed in RFC2409, The Internet Key Exchange (IKE), pp. 16-19. The IPsec cryptographic communication can, as can the TLS cryptographic communication, prevent a communication intercept from any other device than the client and the server. The IPsec cryptographic communication can prevent another client from masquerading as the client during the communication and another server from masquerading as the server during the communication.

A difference between the TLS cryptographic communication and the IPsec cryptographic communication is that the TLS cryptographic communication is technology of Layer 4 of the OSI reference model and the IPsec cryptographic communication is technology of Layer 3 of the OSI reference model. The processing speed of The IPsec cryptographic communication is higher than that of the TLS cryptographic communication. The implementation of the TLS cryptographic communication is easier than that of the IPsec cryptographic communication.

FIG. 16 depicts an exemplary communication sequence for establishing an IPsec cryptographic communication channel between a client and a server.

Between the client and the server, the IPsec cryptographic communication channel is established after an IKE negotiation (SQ1601). Pre-shared key authentication is a representative authentication method performed between the client and the server during the IKE negotiation. Hereinafter, a pre-shared key for the pre-shared key authentication in the IKE negotiation is referred to as an IKE pre-shared key.

### SUMMARY

The above described conventional communication sequence using the TLS installs an X.509 server certificate for the TLS negotiation on a client before factory shipment. The X.509 server certificate has an expiration date. A supplier which has clients in stock, a manufacturer of clines for example, has to manage the expiration dates of the clients with on which X.509 server certificates are installed until shipment. Therefore, the manufacturing and management considering the expiration dates of the X.509 server certificates takes a high cost.

The above described conventional communication sequence using IKE installs an IKE pre-shared key on a client before factory shipment. Installing an IKE pre-shared key before factory shipment cannot avoid the risk that the IKE pre-shared key is stolen by the client manufacturer.

The present invention is created for solving the above described problem and a purpose of the present invention is to provide an information collection system using a gateway that does not need pre-installation of a X.509 server certificate and an IKE pre-shared key.

For solving the above problem, an information collection system and the control method according to an embodiment includes an information processing system, and a gateway connected with the information processing system via a network. The information processing system includes a first server being an initial connection destination of the gateway, a second sever being a transmission destination of measured data from the gateway, and a third server managing the first server and the second server.

The gateway holds gateway information managing an identifier of the gateway and apparatus specific information of the gateway, first server connection destination information, and first server management information managing a created random number and a common key outputted in accordance with a common rule. The gateway transmits a server authentication request including the created random number and the identifier of the gateway to the first server.

The third server hold gateway management information including, for each gateway, apparatus specific information, an identifier and a common key outputted in accordance with a common rule. The third server receives the server authentication request transferred from the first server and creates a first authentication code based on the random number contained in the server authentication request and a common key associated with the gateway in the gateway information. The third server transmits a server authentication response containing first authentication code to the first server.

The gateway receives the server authentication response transferred from the first server and creates a second authentication code based on the created random number and the common key in the first server management information. The gateway makes first determination whether the second authentication code matches the first authentication code contained in the server authentication response. The gateway acquires the server certificate from the first server and stores the server certificate in the first server management information when the second authentication code matches the first authentication code contained in the server authentication response in the first determination.

Further, the gateway information includes a password created in accordance with a common rule. The gateway transmits an entry request containing the password and the identifier of the gateway to the first server after storing the server certificate.

Further, the gateway management information of the third server includes a password created in accordance with a common rule for each gateway. The third server receives the entry request transferred from the first server and makes a third determination whether the password contained in the entry request matches the password for the gateway in the gateway management information. The third server permits the gateway to enter the information processing system and transmits an entry response indicating permission when the password contained in the entry request matches the password for the gateway in the gateway management information in the third determination.

Further, the gateway receives the entry response indicating permission transferred from the first server and transmits to the first server a configuration acquisition request for acquiring configuration information including connection information with the second server.

Further, the third server receive the configuration acquisition request transferred from the first server, and make a fifth determination whether the identifier of the gateway contained in the configuration acquisition request matches an identifier in the gateway management information. when the identifier of the gateway contained in the configuration acquisition request matches an identifier in the gateway management information in the fifth determination, the third server transmits a configuration acquisition response containing first configuration information including a created pre-shared key and second server connection destination information to the first server, and transmits a configuration information notice containing second configuration information including a created pre-shared key and gateway connection source information to the second server.

As a result, the gateway holds the first configuration information contained in the configuration acquisition response transferred from the first server, refers to second server connection destination information, and connects to the second server using the stored pre-shared key.

The present invention allows a gateway to acquire a sever certificate after entering a communication system, resulting in elimination of the need to install the sever certificate on the gateway before shipment.

As a result, the present invention can eliminate the need to manage respective server certificates of gateways before shipment of the gateways, and thus reduce the manufacturing cost for a client manufacturer and the management cost for a supplier with clients in stock.

The present invention allows a gateway to acquire an IKE pre-shared key after entering a communication system, resulting in elimination of the need to install the IKE pre-shared key on the gateway before shipment.

As a result, the present invention can prevent the IKE pre-shared key from being stolen by an outsider, the gateway manufacturer, other than the communication system administrator, and thus improve the security of the entire communication system.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a configuration example of the communication system.

FIG. 2 depicts a configuration example of the GW.

FIG. 3 depicts a GW own node management table.

FIG. 4 depicts an INIT_Site management table.

FIG. 5 depicts an IPsec configuration information storage area provided to the IPsec communication processing unit.

FIG. 6 depicts the configuration of the INIT_Site.

FIG. 7 depicts a sever certificate storage area.

FIG. 8 depicts an integrated management table.

FIG. 9 depicts the configuration of the DCC_Site.

FIG. 10 depicts an IPsec configuration information storage area provided to the IPsec communication processing unit.

FIG. 11 depicts an integrated management.

FIG. 12 depicts a DCC_Site management table.

FIG. 13 depicts a GW management table.

FIG. 14A depicts a communication sequence in the communication system according to an embodiment.

FIG. 14B depicts a communication sequence in the communication system according to an embodiment.

FIG. 15 depicts a representative example of a communication sequence for establishing a Transport Layer Security cryptographic communication channel.

FIG. 16 depicts an exemplary communication sequence for establishing an IPsec cryptographic communication channel between a client and a server.

FIG. 17 depicts TLS connection creation processing by the GW with the INIT_Site.

FIG. 18 depicts random number creation processing and server authentication request transmission processing by the GW.

FIG. 19 depicts reception processing of a server authentication response, validation processing of the INIT_Site and transmission processing of a server certificate acquisition request by the GW.

FIG. 20 depicts reception processing of a sever certificate response and installation processing of the server certificate by the GW.

FIG. 21 depicts entry request transmission processing.

FIG. 22 depicts reception processing of an entry response and transmission processing of a configuration acquisition request by the GW.

FIG. 23 depicts transmission processing of the configuration acquisition request.

FIG. 24 depicts reception processing of the configuration acquisition response by the GW 20.

FIG. 25 depicts INIT_Site main processing by the INIT_Site.

FIG. 26 depicts reception processing of the server authentication request by the INIT_Site.

FIG. 27 depicts reception processing of the server authentication response by the INIT_Site.

FIG. 28 depicts reception processing of the server certificate acquisition request and transmission processing of the server certificate acquisition response by the thread for communication processing with GW of the INIT_Site.

FIG. 29 depicts reception processing of an entry request and transmission processing of the entry request by the thread for communication processing with GW of the INIT_Site.

FIG. 30 depicts reception processing of an entry response by the INIT_Site.

FIG. 31 depicts reception processing of the configuration acquisition request by the INIT_Site.

FIG. 32 depicts reception processing of the configuration acquisition response by the INIT_Site.

FIG. 33 depicts reception processing of the configuration information notice by the DCC_Site.

FIG. 34 depicts reception processing of the server authentication request and transmission processing of the server authentication response by the integrated management.

FIG. 35 depicts reception processing of the entry request, validation processing of the GW and transmission processing of the entry response by the integrated management.

FIG. 36 depicts reception processing of the configuration acquisition request, configuration information creation processing and transmission processing of the configuration acquisition response by the integrated management.

FIG. 37 depicts configuration information creation processing.

### DETAILED DESCRIPTION OF THE EMBODIMENTS

Hereinafter, a communication system according to the present invention is described in detail with reference to the drawings.

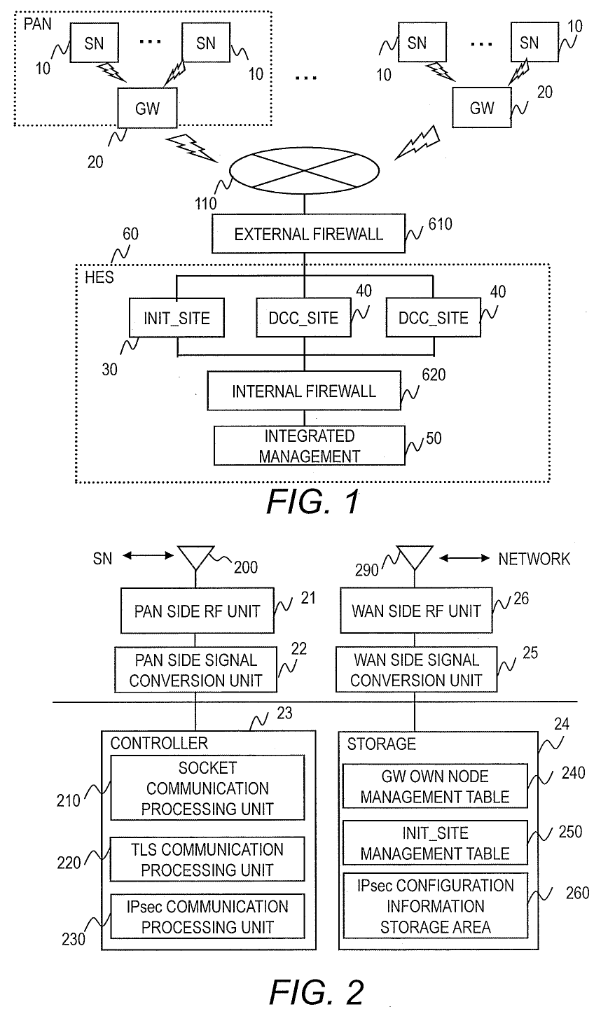

FIG. 1 depicts a configuration example of the communication system.

The communication system is an information collection system and includes a plurality of sensor nodes (SN) 10, gateways (GW) 20 each connected with SNs 10 via channels and a Head End system (HES) 60 to communicate with the GWs 20 via a network 110. An external firewall 610 exists between the network 110 and the HES 60.

The SN 10 is equipped with a sensor and transmits measured data sensed by the sensor to the GW 20. The SN 10 and the GW 20 are connected through a wireless channel. The connection between the SN 10 and the GW 20 is not limited to the wireless channel and may be a wired channel.

The GW 20 transfers the measured data received from the SN 10 to the HES 60. A network including the GW 20 and the plurality of SNs 10 connected with the GW 20 via wireless channels is referred to as a Personal Area Network (PAN). The GW 20 always connects to an Initial Site (INIT_Site) 30 at first when the GW 20 enters the communication network. Therefore, the GW 20 holds in advance the IP address of the INIT_site 30 described below.

The network 110 may be a public wireless network (such as 3G and 4G (LTE)), a public wired network or a LAN. The HES 60 takes the form of cloud computing when the network 110 is a public network and takes the form of on premise when the network 110 is a LAN.

The HES 60 includes the INIT_Site 30, Data Collection & Control Sites (DCC_Site) 40, and an integrated management 50. The INIT_Site 30 is an authentication server to allow each of the GWs 20 to enter the network. The DCC_Site 40 is a server that collects measured data and transmits control messages to GWs 20. The integrated management 50 is a server that manages the GWs 20, the INIT_Site 30 and the DCC_Sites 40.

The INIT_Site 30 is a contact of authentication process for the GW 20 to enter the network.

The DCC_Site 40 communicates with the GWs 20 for a long time. Additional DCC_Sites 40s may be installed in accordance with an increase in the number of the GWs 20. The DCC_Site 40 is a contact for collecting the measured data transmitted from the GW 20 and controlling the GW 20.

The integrated management 50 is a server that aggregates and holds the measured data collected by the sensors of the SNs 10. The integrated management 50 is a server that determines whether to permit the GW 20 to enter the network and holds important information for the determination. Thus, the internal firewall 620 is installed between the integrated management 50 and the INIT_Site 30 and the DCC_Sites 40 for protecting the integrated management 50 from security attacks. An administrator logs in the integrated management 50 to remotely control the GW 20 through the DCC_Site 40.

As described above, the integrated management 50, the INIT_Site 30 and the DCC_Sites 40 are separated, and thus it is possible to install a firewall between the integrated management 50 and the group of the INIT_Site 30 and the DCC_Sites 40, resulting in an improvement in the system security.

FIG. 2 depicts a configuration example of the GW 20. In this example, the GW 20 is connected with the SN 10 via the wireless channel and the GW 20 is connected with the HES 60 via the network 110; however, the connection means is not limited to the wireless communication.

The GW 20 includes antennas 200 and 290, a PAN side RF unit 21 that transmits and receives radio signals to and from the SNs 10 via the antenna 200, a PAN side signal conversion unit 22 that modulates/demodulates radio signals, a WAN side RF unit 26 that transmits and receives radio signals to and from the network 110 via the antenna 290, a WAN side signal conversion unit 25 that modulates/demodulates of radio signals, a controller 23, and storage 24 connected with the controller 23.

The controller 23 is a processor executing programs, for example. The controller 23 includes a socket communication processing unit 210 for communication with the HES 60, a TLS communication processing unit 220 allowing the TLS cryptographic communication, and an IPsec communication processing unit 230 allowing the IPsec cryptographic communication. The TLS communication processing unit 220 is used for communication with the INIT_Site 30. The IPsec communication processing unit 230 is used for communication with the DCC_Site 40.

The storage 24 holds a GW own node management table 240 containing information regarding the GW 20 itself, an INIT_Site management table 250 containing the information regarding communication with the INIT_Site 30, and an IPsec configuration information storage area 260 holding configuration information to be provided to the IPsec communication processing unit 230.

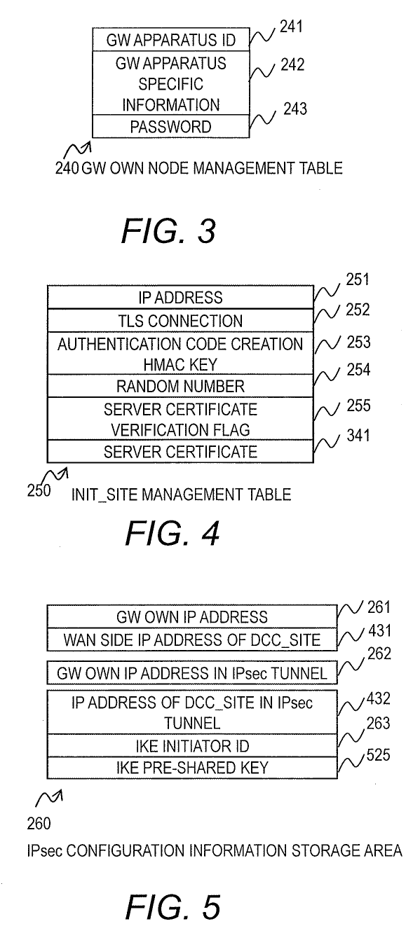

FIG. 3 depicts the GW own node management table 240.

The GW own node management table 240 contains a GW apparatus ID 241, which is a unique identifier for the GW 20, GW apparatus specific information 242 and a password 243 for indicating to the HES 60 that the GW 20 itself is an apparatus of the communication system. The GW apparatus ID 241 and the GW apparatus specific information 242 are pre-stored before the activation of the GW 20.

The password 243 is outputted after the activation of the GW 20 using the GW apparatus specific information 242 as input in accordance with a rule defined between the GW 20 and the HES 60. The rule is defined in advance before operation of the communication system by a system designer of the GW 20 and the HES 60. The rule is already written in the GW 20 at shipment.

Creating the password 243 after the activation of the GW 20 results in that the password 243 does not exist in the GW 20 during manufacturing, and thus the password 243 is never stolen by the manufacturer. An example of the GW apparatus specific information 242 is the MAC address of the GW 20. Any type of unique information may be selected for the GW apparatus specific information 242. The GW apparatus specific information 242 does not have an expiration date because the GW apparatus specific information 242 is unique to the GW 20. In other word, the GW apparatus specific information 242 can be outputted at the time when the GW 20 needs the GW apparatus specific information 242 irrespective of the expiration date.

FIG. 4 depicts the INIT_Site management table 250.

The INIT_Site management table 250 contains an IP address 251 of the INIT_Site 30, a TLS connection 252, an authentication code creation HMAC key 253, a random number 254, a server certificate verification flag 255 and a server certificate 341.

The TLS connection 252 holds the TLS connection with the INIT_Site 30.

The authentication code creation HMAC key 253 and the random number 254 are used to create an authentication code for confirming that a connected INIT_Site is not a false server. The authentication code creation HMAC key 253 is outputted after the activation of the GW 20 using the GW apparatus specific information 242 as input in accordance with a rule defined between the GW 20 and the HES 60. The rule is defined in advance before the operation of the communication system by a system designer of the GW 20 and the HES 60. The rule is already written in the GW 20 at shipment.

Creating the authentication code creation HMAC key 253 after the activation of the GW 20 results in that the authentication code creation HMAC key 253 does not exist in the GW 20 during manufacturing, and thus the authentication code creation HMAC key 253 is never stolen by the manufacturer. An example of the GW apparatus specific information 242 is the MAC address of the gateway 20. Any type of unique information may be selected for the GW apparatus specific information 242. The GW apparatus specific information 242 does not have an expiration date because the GW apparatus specific information 242 is unique to the GW 20. In other word, the authentication code creation HMAC key 253 can be outputted at the time when the GW 20 needs the GW apparatus specific information 242 irrespective of the expiration date.

The server certificate verification flag 255 indicates whether the server authentication using the X.509 server certificate is performed in a negotiation with the INIT_Site 30. If the server certificate verification flag 255 indicates “Disable”, it means that the server authentication is not performed in the TLS negotiation. On the other hand, if the server certificate verification flag 255 indicates “Enable”, it means that the server authentication is performed in the TLS negotiation. The initial value of the server certificate verification flag 255 indicates “Disable”.

The server certificate 341 holds the X.509 server certificate of the INIT_Site 30 transmitted from the INIT_Site 30.

FIG. 5 depicts the IPsec configuration information storage area 260 provided to the IPsec communication processing unit 230.

The IPsec configuration information storage area 260 holds a GW own IP address 261, a WAN side IP address of a DCC_Site 431, a GW own IP address in an IPsec tunnel 262, an IP address of the DCC_Site in the IPsec tunnel 432, an IKE initiator ID 263 and an IKE pre-shared key 525.

The GW own IP address 261 holds the IP address of the GW 20 allocated from the network 110 to the GW 20 after the activation of the GW 20.

The WAN side IP address of the DCC_Site 431 holds the WAN side IP address of the connected DCC_Site 40.

The GW own IP address in the IPsec tunnel 262 holds the IP address of the GW 20 in the IPsec tunnel with the connected DCC_Site 40.

The IP address of the DCC_Site in the IPsec tunnel 432 holds the IP address of the DCC_Site 40 in the IPsec tunnel.

The IKE initiator ID 263 is used for the IPsec communication processing unit of the DCC_Site 40 to search for the IKE pre-shared key 525 in the IKE negotiation. The IKE initiator ID 263 is transmitted by the IPsec communication processing unit 230 of the GW 20, which is the initiator in the IKE, during the IKE negotiation.

The IKE pre-shared key 525 holds the IKE pre-shared key transmitted from the INIT_Site 30. The IKE pre-shared key 525 is used in the pre-shared key authentication in the IKE negotiation with the DCC_Site 40.

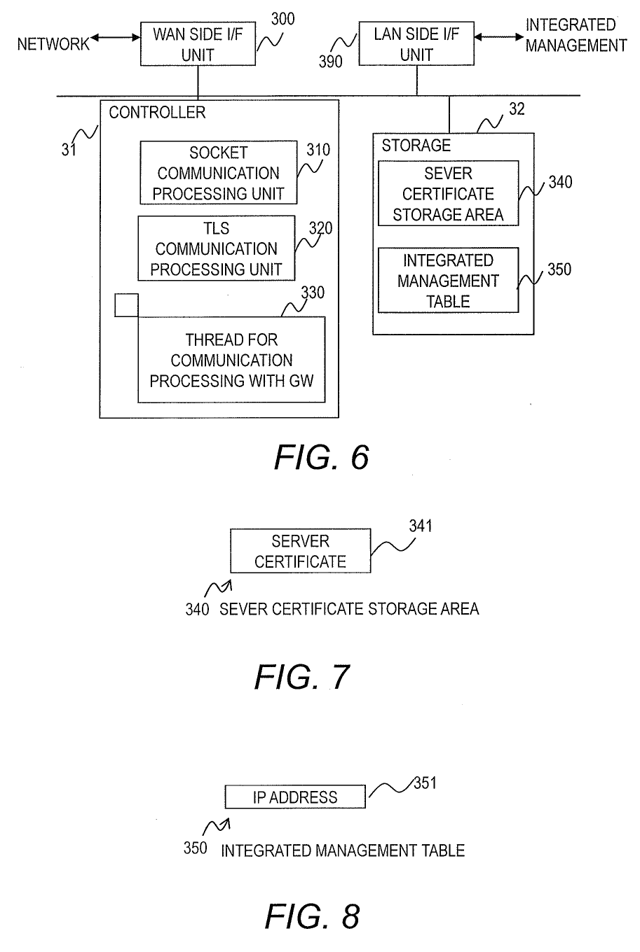

FIG. 6 depicts the configuration of the INIT_Site 30.

The INIT_Site 30 includes a WAN side I/F unit 300, a LAN side I/F unit 390, controller 31 and storage 32. The WAN side I/F unit 300 is a communication interface with the network 110. The LAN side I/F unit 390 is a communication interface with the integrated management 50.

The controller 31 is a processor executing programs, for example. The controller 31 includes a socket communication processing unit 310 for communication with the GWs 20 and the integrated management 50, a TLS communication processing unit 320 allowing the TLS cryptographic communication, and a thread for communication processing with GW 330 created for each TLS connection with the GW 20.

The storage 32 includes a sever certificate storage area 340 holding the X.509 server certificate of the INIT_Site 30 itself and an integrated management table 350 holding information on communication with the integrated management 50.

FIG. 7 depicts the sever certificate storage area 340. The sever certificate storage area 340 holds a server certificate 341 containing the X.509 server certificate of the INIT_Site 30 itself. The X.509 server certificate of the INIT_Site 30 is stored in the server certificate 341 prior to the activation of the GW 20.

FIG. 8 depicts the integrated management table 350.

The integrated management table 350 includes an IP address 351 holding the IP address of the integrated management 50. The IP address of the integrated management 50 is stored in the IP address 351 prior to the activation of the GW 20.

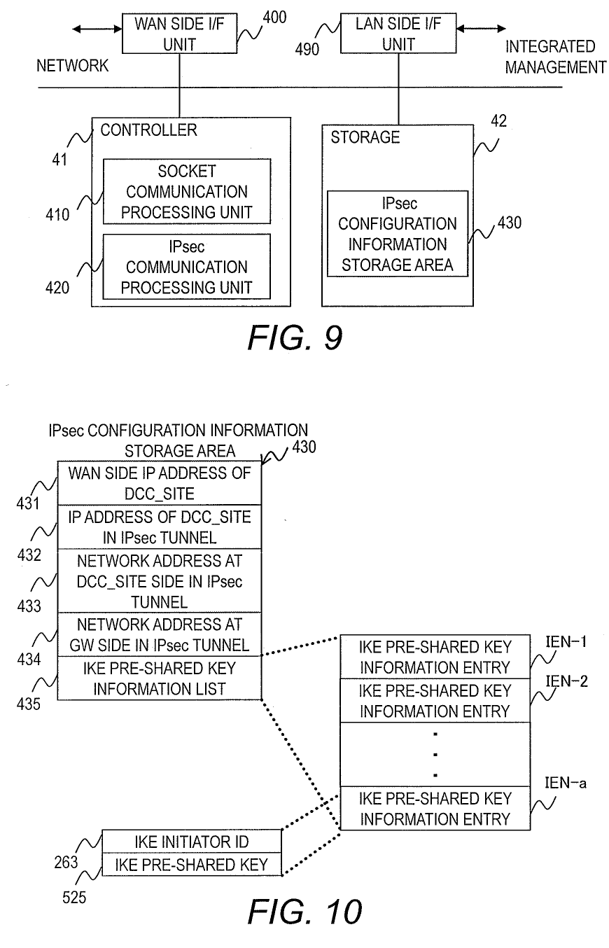

FIG. 9 depicts the configuration of the DCC_Site 40.

The DCC_Site 40 includes a WAN side I/F unit 400, a LAN side I/F unit 490, a controller 41 and storage 42. The WAN side I/F unit 400 is a communication interface unit with the network 110. The LAN side I/F unit 490 a communication interface unit with the integrated management 50.

The controller 41 is a processor executing programs, for example. The controller 41 includes a socket communication processing unit 410 for communication with the GW 20s and the integrated management 50, and an IPsec communication processing unit 420 allowing the IPsec cryptographic communication.

The storage 42 includes an IPsec configuration information storage area 430 holding the configuration information provided to the IPsec communication processing unit 420.

FIG. 10 depicts the IPsec configuration information storage area 430 provided to the IPsec communication processing unit 420.

The IPsec configuration information storage area 430 holds a WAN side IP address of the DCC_Site 431, an IP address of the DCC_Site in the IPsec tunnel 432, a network address at the DCC_Site side in the IPsec tunnel 433, and a network address at the GW side in IPsec tunnel 434 and an IKE pre-shared key information list 435.

The WAN side IP address of the DCC_Site 431 holds the WAN side IP address of the DCC_Site 40 itself. The WAN side IP address of the DCC_Site 40 is pre-stored in the WAN side IP address of the DCC_Site 431 prior to the activation of the GW 20.

The IP address of the DCC_Site in the IPsec tunnel 432 holds the IP address of the DCC_Site 40 itself in the IPsec tunnel with the GW 20. The IP address of the DCC_Site 40 itself in the IPsec tunnel with the GW 20 is pre-stored in the IP address of the DCC_Site in the IPsec tunnel 432 prior to the activation of the GW 20.

The network address at the DCC_Site side in the IPsec tunnel 433 stores the network address at the DCC_Site 40 side in the IPsec tunnel. The network address at the DCC_Site 40 side in the IPsec tunnel is pre-stored in the network address at the DCC_Site side in the IPsec tunnel 433 prior to the activation of the GW 20.

The network address at the GW side in the IPsec tunnel 434 holds the network address at the GW 20 side in the IPsec tunnel. The network address at the GW 20 side in the IPsec tunnel is stored in the network address at the GW side in the IPsec tunnel 434 prior to the activation of the GW 20.

The IKE pre-shared key information list 435 holds information used in the IKE negotiation with the GW 20. The IKE pre-shared key information list 435 contains respective information entries for initiators of IKE and they are IKE pre-shared key information entries IEN-1 to IEN-a. In this example, the initiator of IKE is the GW 20.

The IKE pre-shared key information entry IEN contains an IKE initiator ID 263 and the IKE pre-shared key 525.

The IKE initiator ID 263 is used for the IPsec communication processing unit 420 that negotiates with a plurality of initiators to determine for which initiator the IKE pre-shared key is used.

The IKE pre-shared key 525 is identified by the IKE initiator ID 263.

As described above, the IKE initiator ID is transmitted from the IPsec communication processing unit 230 of the GW 20 during the IKE negotiation. The IPsec communication processing unit 420 of the DCC_Site 40 searches the IKE pre-shared key information list 435 for the IKE initiator ID and determine the IKE pre-shared key 525 to be used.

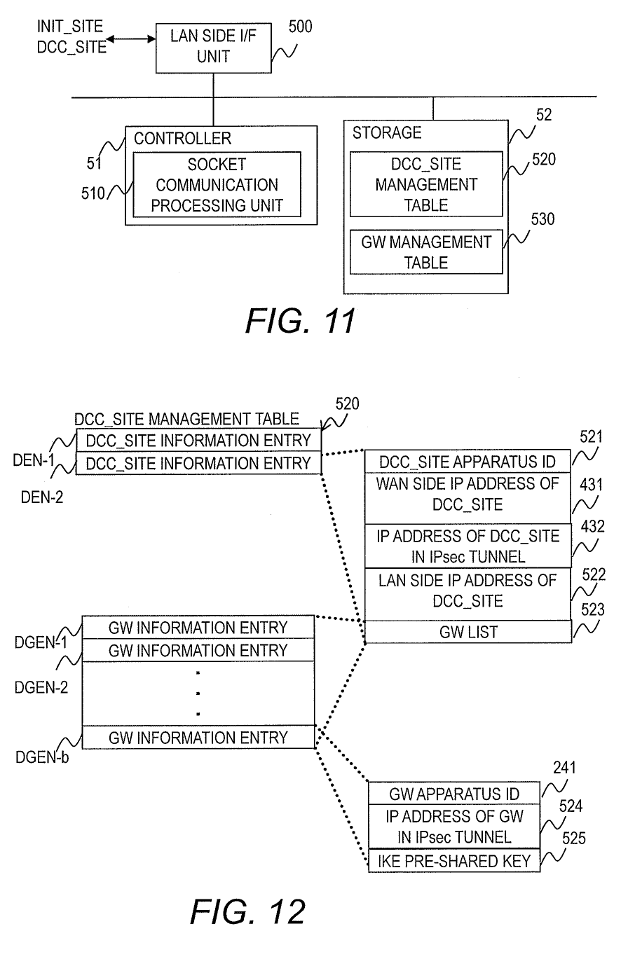

FIG. 11 depicts the integrated management 50.

The integrated management 50 includes a LAN side I/F unit 500, controller 51 and storage 52. The LAN side I/F unit 500 is an interface unit with the INIT_Site 30 and the DCC_Site 40.

The controller 51 is a processor executing programs, for example. The controller 51 includes a socket communication processing unit 510 for communication with the INIT_Site 30 and the DCC_Site 40.

The storage 52 holds a DCC_Site management table 520 containing information regarding communication between the DCC_Site 40 and the GW 20 in addition to information on the DCC_Site 40, and a GW management table 530 containing information on authentication of the GW 20.

FIG. 0.12 depicts the DCC_Site management table 520.

The DCC_Site management table 520 contains DCC_Site information entries DEN including information on the DCC_Sites 40. The number of the DCC_Site information entries DEN corresponds to the number of the DCC_Sites 40. In this example, the number of the DCC_Sites 40 in the HES 60 is two, and thus the number of the DCC_Site information entries DEN is two. The DCC_Site information entries DEN-1 and DEN-2 each contain information on each DCC_Site 40.

The DCC_Site information entry DEN-j (j=1, 2) contains a DCC_Site apparatus ID 521, the WAN side IP address of the DCC_Site 431, the IP address of the DCC_Site in the IPsec tunnel 432, a LAN side IP address of the DCC_Site 522, and a GW list 523.

The DCC_Site apparatus ID 521 is used for identifying the DCC_Site 40-j in the communication system. The DCC_Site apparatus ID 521 is stored prior to the activation of the GW 20.

The WAN side IP address of the DCC_Site 40-j is stored in the WAN side IP address of the DCC_Site 431. The WAN side IP address of the DCC_Site 40-j is stored in the WAN side IP address of the DCC_Site 431 prior to the activation of the GW 20.

The IP address of the DCC_Site 40-j in the IPsectunnel between the DCC_Site 40-j and the GW 20 is stored in the IP address of the DCC_Site in the IPsec tunnel 432. The IP address of the DCC_Site 40-j in the IPsectunnel between the DCC_Site 40-j and the GW 20 is stored in the IP address of the DCC_Site in the IPsec tunnel 432 prior to the activation of the GW 20.

The LAN side IP address of the DCC_Site 40-j is stored in the LAN side IP address of the DCC_Site 522. The LAN side IP address of the DCC_Site 40-j is stored in the LAN side IP address of the DCC_Site 522 prior to the activation of the GW 20.

Information on all the GWs 20 connected with the DSS_Site 40-j is stored in the GW list 523. The GW list 523 contains an information entry for each GW 20, and the entries correspond to the GW information entries DGEN-1 to DGEN-b, respectively.

The GW information entries DGEN includes the GW apparatus ID 241, an IP address of the GW in the IPsec tunnel 524 and an IKE pre-shared key 525. The GW apparatus ID 241 is used to identify the GW 20 in the communication system. The IP address of the GW 20 in the IPsectunnel between the DSS_Site 40 and the GW 20 is stored in the IP address of the GW in the IPsec tunnel 524. The pre-shared key for pre-shared key authentication in the IKE negotiation between the DSS_Site 40 and the GW 20 is stored in the IKE pre-shared key 525. The GW apparatus ID 241 and the IP address of the GW in the IPsec tunnel 524 are pre-stored prior to the activation of the GW 20.

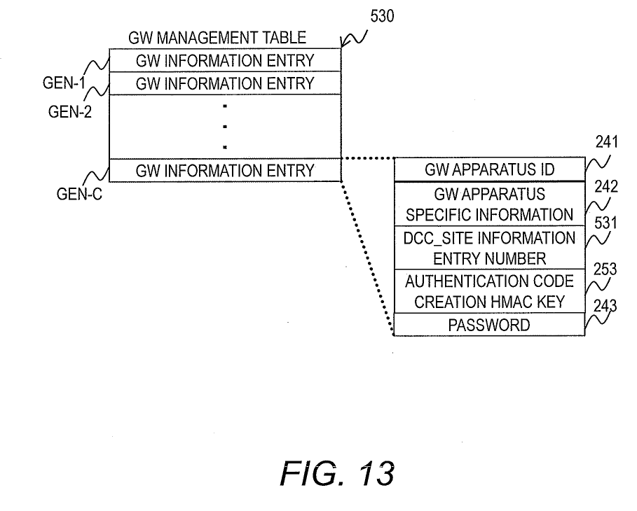

FIG. 13 depicts the GW management table 530.

The GW management table 530 contains information on all the GW 20s existing in the field. The GW management table 530 contains an entry for each GW 20 and the entries correspond to the GW information entries GEN-1 to GEN-c, respectively.

The GW information entry contains the GW apparatus ID 241, a GW apparatus specific information 242, a DCC_Site information entry number 531, the authentication code creation HMAC key 253, and a password 243. The GW apparatus ID 241 identify the GW 20 in the communication system. The GW apparatus specific information 242 is specific (unique) information on the apparatus of the GW 20. The number of the DCC_Site information entry DEN of the DCC_Site 40 connected with the GW 20 is stored in the DCC_Site information entry number 531. The authentication code creation HMAC key 253 is used to indicate to the GW 20 that the INIT_Site 30 is an apparatus in the communication system. The password 243 is used to confirm that the GW 20 is an apparatus of the communication system. The GW apparatus ID 241, the GW apparatus specific information 242, and the DCC_Site information entry number 531 are pre-stored prior to the activation of the GW 20.

The authentication code creation HMAC key 253 and the password 243 are outputted using the GW apparatus specific information 242 as input information prior to the activation of the GW 20 in accordance with a rule defined between the integrated management 50 and the GW 20. Therefore, the authentication code creation HMAC key 253 in the GW management table 530 is identical to the authentication code creation HMAC key 253 in the INIT_Site management table 250. The password 243 in the GW management table 530 is identical to the authentication code creation HMAC key 253 in the GW own node management table 240 of the GW 20.

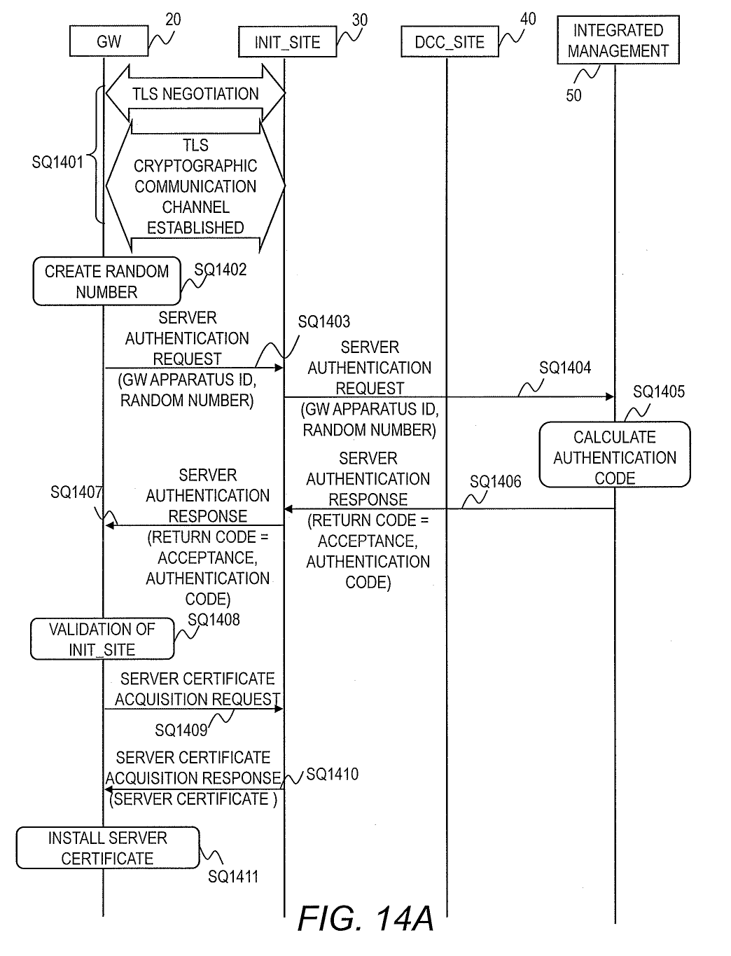

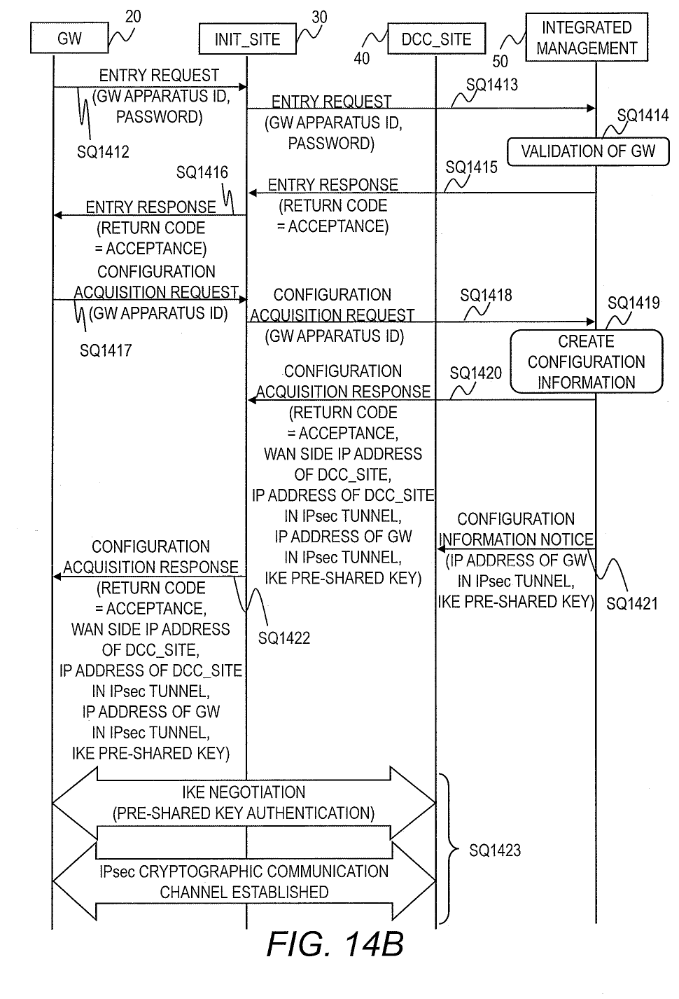

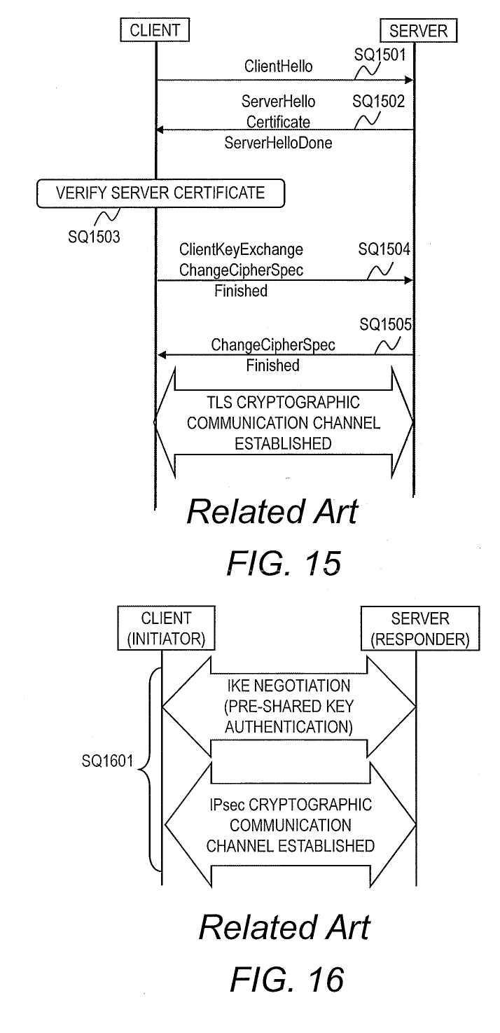

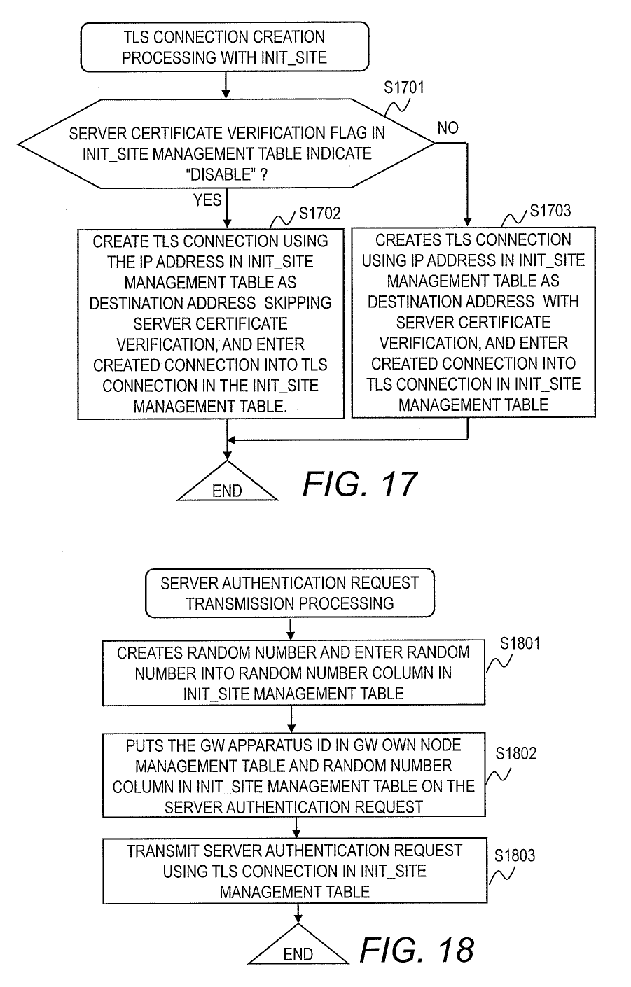

FIGS. 14A and 14B depict a communication sequence in the communication system according to an embodiment. SQ1401 to SQ1423 in FIGS. 14 A and 14B will be described with reference to FIGS. 17 to 37.

The processing described below is implemented by the controllers of the SN 10, the GW 20, the INIT_Site 30, the DCC_Site 40 and the integrated management 50 performing programs; however, hereinafter, the processing performed by programs and threads will be described for convenience of explanation.

<SQ1401> Upon the activation of the GW 20, the GW 20 starts a TLS negotiation with the INIT_Site 30 in the TLS connection creation processing with the INIT_Site 30. A TLS cryptographic communication channel is established between the GW 20 and the INIT_Site 30. The TLS cryptographic communication channel corresponds to the TLS connection.

The TLS connection creation processing by the GW 20 with the INIT_Site is described with reference to FIG. 17.

In S1701, the GW 20 determines whether the server certificate verification flag in the INIT_Site management table 250 indicates “Disable”.

If the determination is Yes in S1701, the GW 20, in S1702, creates the TLS connection using the IP address 251 in the INIT_Site management table 250 as the destination address in the skip mode in which the server certificate verification is skipped. The GW 20 enters information on the created TLS connection into the TLS connection 252 in the INIT_Site management table 250. Since the TLS connection is created in the server certificate verification skip mode, the verification of the server certificate 341 transmitted from the INIT_Site 30 during the TLS negotiation will be skipped.

If the determination is NO in S1701, the GW 20, in S1703, creates the TLS connection using the IP address 251 in the INIT_Site management table 250 as the destination address without skipping the server certificate verification. The GW 20 enters information on the created TLS connection into the TLS connection 252 in the INIT_Site management table 250.

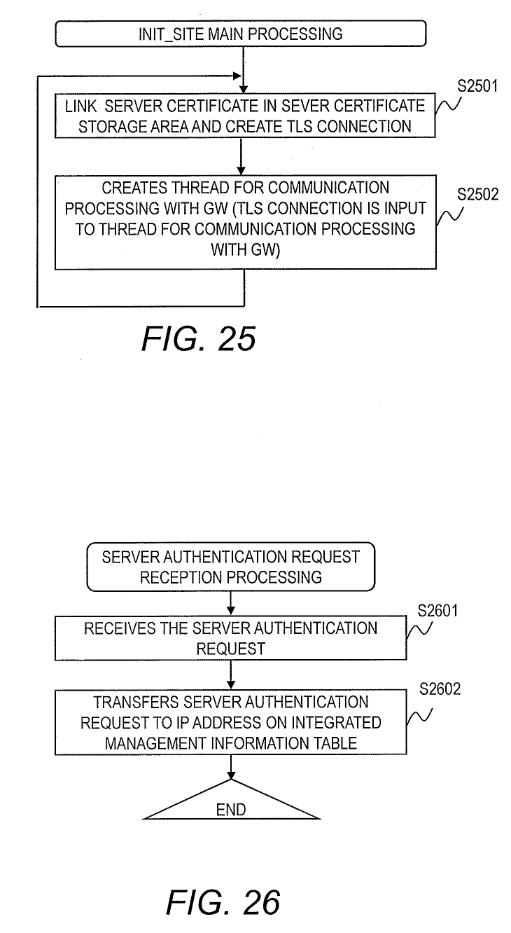

The INIT_Site main processing by the INIT_Site 30 corresponding to SQ1401 in FIG. 14A is described with reference to FIG. 25.

In S2501, the TLS connection is created upon receipt of a TLS negotiation from the GW 20. The server certificate 341 is transmitted to the GW 20 in the TLS negotiation by linking the server certificate 341 in the sever certificate storage area 340.

In S2502, the INIT_Site 30 creates a thread for communication processing with GW 330 upon the creation of the TLS connection, and provides the TLS connection to the thread for communication processing with GW 330. Then, the communication with the GW 20 is handled by the thread for communication processing with GW 330.

<SQ1402> After the TLS cryptographic communication channel is established between the GW 20 and the INIT_Site 30, the GW 20 creates a random number to determine the connected INIT_Site 30 is an apparatus in the communication system.

<SQ1403> The GW 20 transmits the random number created in SQ1402 on a server authentication request to the INIT_Site 30.

<SQ1404> The INIT_Site 30 receives the authentication request from the GW 20 and transfers the authentication request to the integrated management 50.

The random number creation processing and the server authentication request transmission processing by the GW 20 in SQ1402 and SQ1403 are described with reference to FIG. 18.

In S1801, the GW 20 creates a random number and enters the random number into the random number 254 in the INIT_Site management table 250. This random number is used in the validation of the INIT_Site (SQ1408 in FIG. 14A) described later.

In S1802, the GW 20 puts the GW apparatus ID 241 in the GW own node management table 240 and the random number 254 in the INIT_Site management table 250 on the server authentication request.

In S1803, the GW 20 transmits the server authentication request to the INIT_Site 30 using the TLS connection 252 in the INIT_Site management table 250.

The reception processing of the server authentication request by the INIT_Site 30 corresponding to SQ1403 and SQ1404 is described with reference to FIG. 26

In S2601, the thread for communication processing with GW 330 of the INIT_Site 30 receives the server authentication request from the GW 20.

In S2602, the thread for communication processing with GW 330 of the INIT_Site 30 transfers the server authentication request to the integrated management 50 using the IP address 351 on the integrated management information table 350 as the destination address (SQ1404).

<SQ1405> Upon receipt of the server authentication request from the INIT_Site 30, the integrated management 50 calculates a authentication code using the random number on the server authentication request for indicating the INIT_Site 30 is an apparatus of the communication system.

<SQ1406> The integrated management 50 transmits the authentication code calculated in SQ1405 on a server authentication response to the INIT_Site 30.

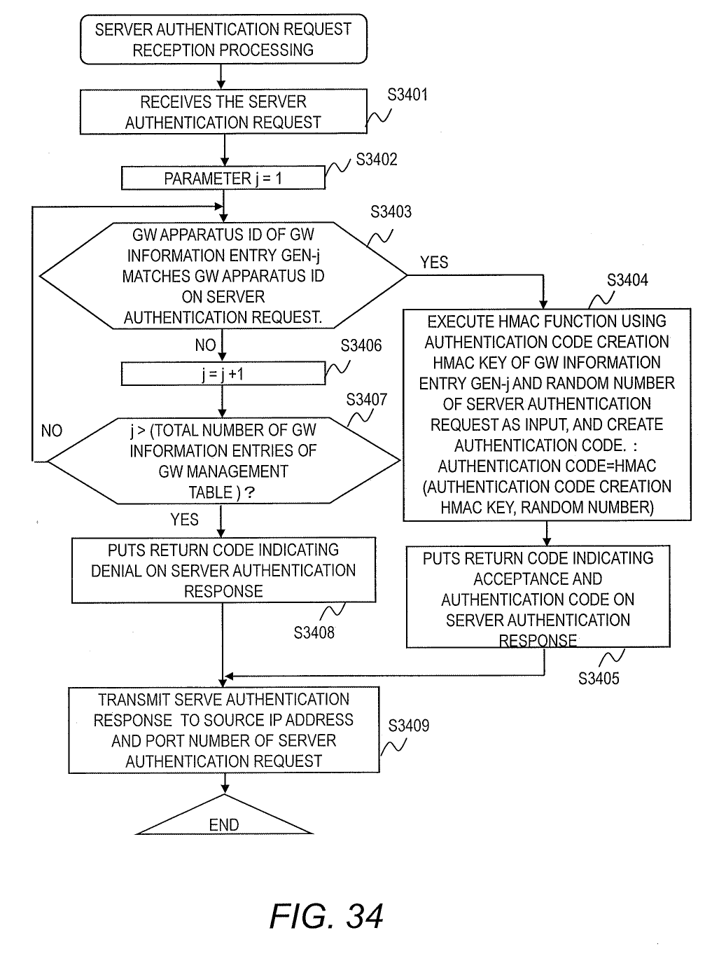

The reception processing of the server authentication request and the transmission processing of the server authentication response by the integrated management 50 are described with reference to FIG. 34

In S3401, the integrated management 50 receives the server authentication request from the INIT_Site 30.

In S3402, the integrated management 50 prepares a parameter j for searching the GW management table 530 for a GW information entry GEN with the GW apparatus ID 241 matching the GW apparatus ID on the received server authentication request. The search processing corresponds to S3403, S3406 and S3407.

In S3403, the integrated management 50 determines whether the GW apparatus ID 241 of the GW information entry GEN-j matches the GW apparatus ID on the server authentication request.

If it is determined that the GW apparatus ID 241 of the GW information entry GEN-j matches the GW apparatus ID on the server authentication request, in short, the determination result in S3430 is Yes, the integrated management 50, in S3404, executes an HMAC function using the authentication code creation HMAC key 253 of the GW information entry GEN-j and the random number of the server authentication request as input, and creates an authentication code. SQ1403, SQ1404 and SQ1405 correspond to the case when the determination is Yes in S3403.

In S3405, the integrated management 50 puts a return code indicating acceptance and the authentication code created in S3404 on the server authentication response. The return code is used for the integrated management 50 to indicate the type of the response result to the INIT_Site 30 and the GW 20.

In S3409, the integrated management 50 transmits the serve authentication response containing the return code indicating acceptance and the created authentication code to the INIT_Site 30, using the source IP address and the port number of the server authentication request as the destination information.

On the other hand, if it is determined that the GW apparatus ID 241 of the GW information entry GEN-j does not match the GW apparatus ID on the server authentication request, in short, the determination result in S3430 is NO, the integrated management 50 increments j to check the next GW information entry GEN in S3406.

In S3407, the integrated management 50 determines whether j is over the total number of the GW information entries of the GW management table 530.

If j is not over the total number of the GW information entries, in short, the determination result in S3407 is NO, the integrated management 50, in S3403, determines again whether the GW apparatus ID 241 of the GW information entry GEN-j matches the GW apparatus ID on the server authentication request.

If j is over the total number of the GW information entries, in short, the determination result in S3407 is YES, the integrated management 50, in S3408, puts the return code indicating denial on the server authentication response.

In S3409, the integrated management 50 transmits the serve authentication response containing the return code indicating denial to the INIT_Site 30, using the source IP address and the port number of the server authentication request as the destination information.

<SQ1407> Upon receipt of the serve authentication response from the integrated management 50, the INIT_Site 30 transfers the serve authentication response to the GW 20.

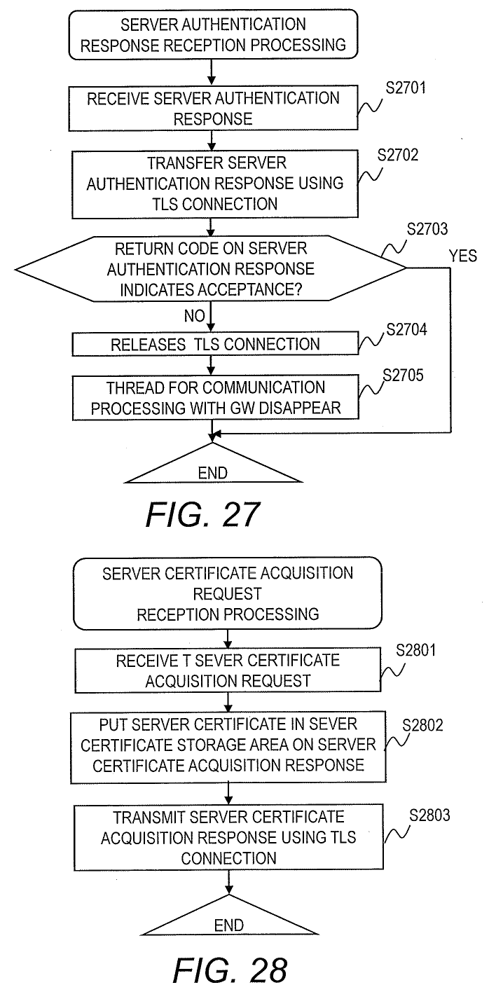

The reception processing of the server authentication response by the INIT_Site 30 is described with reference to FIG. 27.

In S2701, the thread for communication processing with GW 330 of the INIT_Site 30 receives the server authentication response from the integrated management 50.

In S2702, the thread for communication processing with GW 330 of the INIT_Site 30 transfers the server authentication response to the GW 20 using the TLS connection taken from the INIT_Site main processing (FIG. 25).

In S2703, the thread for communication processing with GW 330 of the INIT_Site 30 determines whether the return code on the server authentication response indicates acceptance.

If the return code on the server authentication response indicates acceptance, in short, the determination result in S2703 is YES, the thread for communication processing with GW 330 of the INIT_Site 30 ends the server authentication response reception processing. SQ1407 in FIG. 14A corresponds to the case when the determination result in S2703 is YES.

If the return code on the server authentication response indicates denial instead of acceptance, in short, the determination result in S2703 is NO, the opposite communication apparatus is not registered. Thus, in S2704, the thread for communication processing with GW 330 releases the TLS connection taken from the INIT_Site main processing (FIG. 25). Then, in S2705, the thread for communication processing with GW 330 disappears.

<SQ1408> Upon receipt of the server authentication response from the INIT_Site 30 in SQ1407, the GW 20 determines whether the INIT_Site 30 is an apparatus of the communication system with reference to the authentication code on the server authentication response.

<SQ1409> The GW 20 transmits a server certificate acquisition request to the INIT_Site 30 for acquiring the sever certificate of the INIT_Site 30.

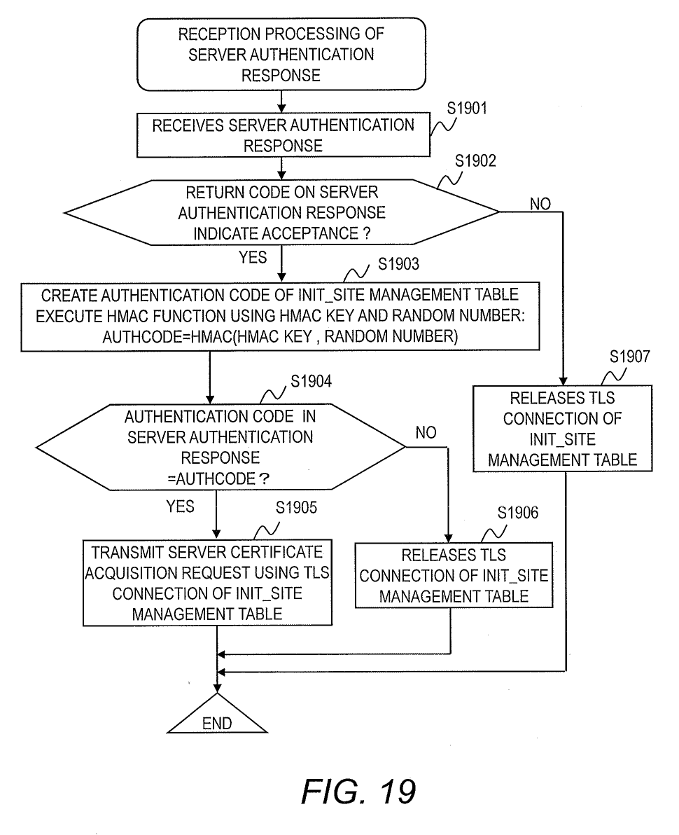

The reception processing of the server authentication response, the validation processing of the INIT_Site and the transmission processing of the server certificate acquisition request by the GW 20 are described with reference to FIG. 19.

In S1901, the GW 20 receives the server authentication response from the INIT_Site 30.

In S1902, the GW 20 determines whether the return code on the server authentication response indicates acceptance.

If the return code on the server authentication response indicates acceptance, in short, the determination result in S1902 is YES, the GW 20, in S1903, executes the HMAC function using the authentication code creation HMAC key 253 and the random number 254 in the INIT_Site management table 250 as input information. SQ1407 in FIG. 14A corresponds to the case when the determination is YES in S1902.

AuthCode=HMAC (authentication code creation HMAC key 253, random number 254)

In S1904, the GW 20 determines whether the authentication code on the server authentication response matches AuthCode in S1903.

If the authentication code on the server authentication response matches AuthCode, in short, the determination result in S1904 is YES, the GW 20 determines that the INIT_Site 30 is an apparatus of the communication system and proceeds to S1905.

The validation of the INIT_Site (SQ1408) in FIG. 14A corresponds to S1903 and S1904.

In S1905, the GW 20 transmits the server certificate acquisition request to the INIT_Site 30 using the TLS connection 252 of INIT_Site management table 250. S1409 in FIG. 14A corresponds to S1905.

If the determination result in S1902 or S1904 is NO, the GW 20, in S1906, releases the TLS connection 252 of the INIT_Site management table 250.

<SQ1410> Upon receipt of the server certificate acquisition request in SQ1409, the INIT_Site 30 transmits the sever certificate of the INIT_Site 30 on a server certificate acquisition response to the GW 20.

The reception processing of the server certificate acquisition request and the transmission processing of the server certificate acquisition response by the thread for communication processing with GW 330 of the INIT_Site 30 are described with reference to FIG. 28.

In S2801, the thread for communication processing with GW 330 of the INIT_Site 30 receives the sever certificate acquisition request from the GW 20.

In S2802, the thread for communication processing with GW 330 of the INIT_Site 30 puts the server certificate 341 in the sever certificate storage area 340 on the server certificate acquisition response.

In S2803, the thread for communication processing with GW 330 of the INIT_Site 30 transmits the server certificate acquisition response to the GW 20 using the TLS connection taken from the INIT_Site main processing (FIG. 25). SQ1410 in FIG. 14 corresponds to S2803.

<SQ1411> Upon receipt of the server certificate acquisition response from the INIT_Site 30 in SQ1410, the GW 20 installs the server certificate on the server certificate acquisition response.

<SQ1412> The GW 20 transmits an entry request with a password to the INIT_Site 30 for indicating to the HES 60 that the GW 20 itself is an apparatus of the communication system.

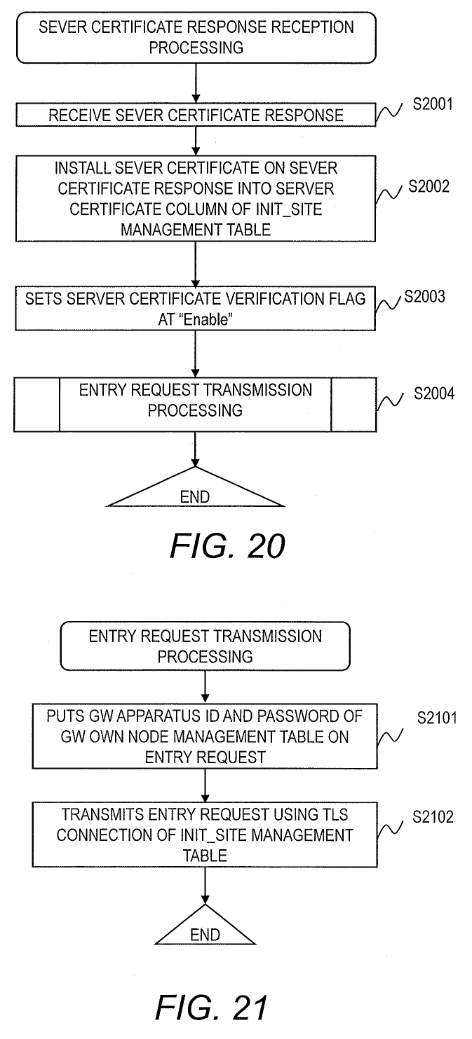

The reception processing of the sever certificate response and the installation processing of the server certificate by the GW 20 are described with reference to FIG. 20.

In S2001, the GW 20 receives the sever certificate response from the INIT_Site 30.

In S2002, the GW 20 installs the sever certificate on the sever certificate response into the server certificate 341 of the INIT_Site management table 250 because it is confirmed that the INIT_Site 30 is an apparatus of the communication system by the validation of the INIT_Site (SQ1408). SQ1411 in FIG. 14A corresponds to S2002.

In S2003, the GW 20 sets the server certificate verification flag 255 at “Enable”. It causes the GW 20 to compare, for verification, the server certificate transmitted from the INIT_Site and the server certificate 341 of the INIT_Site management table 250 in the TLS negotiation with the INIT_Site 30 from the next time to validate the INIT_Site 30.

In S2004, the GW 20 performs the entry request transmission processing. The entry request transmission processing by the GW 20 is performed for indicating to the HES 60 that the GW 20 is an apparatus of the communication system.

The entry request transmission processing in S2004 is described with reference to FIG. 21.

In S2101, the GW 20 puts the GW apparatus ID 241 and the password 243 of the GW own node management table 240 on the entry request.

In S2102, the GW 20 transmits the entry request to the INIT_Site 30 using the TLS connection 252 of the INIT_Site management table 250. SQ1412 in FIG. 14B corresponds to S2102.

<SQ1413> Upon receipt of the entry request from the GW 20, the INIT_Site 30 transfers the entry request to the integrated management 50.

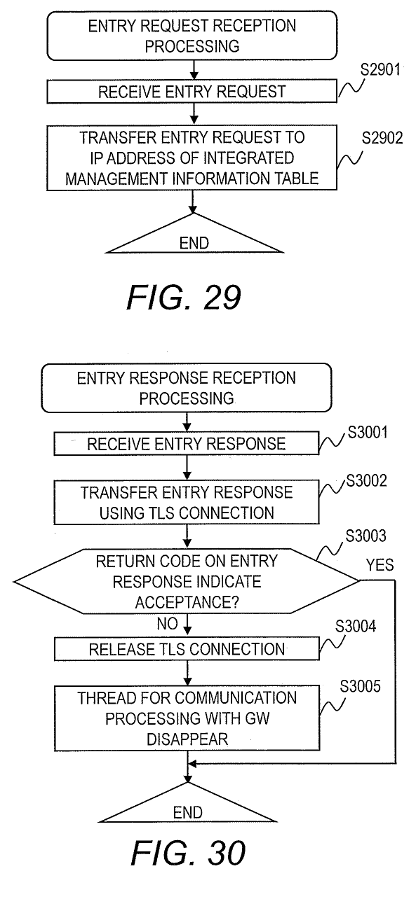

The reception processing of the entry request and the transmission processing of the entry request by the thread for communication processing with GW 330 of the INIT_Site 30 is described with reference to FIG. 29.

In S2901, the thread for communication processing with GW 330 of the INIT_Site 30 receives the entry request from the GW 20.

In S2902, the thread for communication processing with GW 330 of the INIT_Site 30 transfers the entry request to the integrated management 50 using the IP address 351 of the integrated management information table 350 as the destination information. SQ1413 in FIG. 14B corresponds to S2902.

<SQ1414> Upon receipt of the entry request from the INIT_Site 30 in SQ1413, the integrated management 50 confirms whether the GW 20 is an apparatus of the communication system using the password on the entry request.

<SQ1415> The integrated management 50 transmits an entry response containing a return code of acceptance to the INIT_Site 30 because it is confirmed that the GW 20 is an apparatus of the communication system in SQ1414.

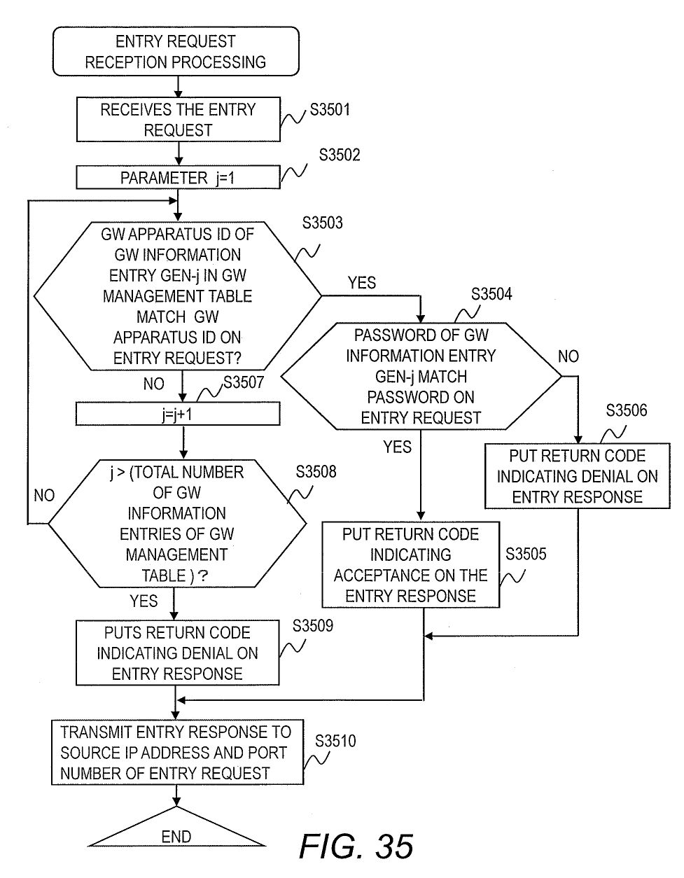

The reception processing of the entry request, the validation processing of the GW and the transmission processing of the entry response by the integrated management 50 are described with reference to FIG. 35.

In S3501, the integrated management 50 receives the entry request from the INIT_Site 30.

In S3502, the integrated management 50 prepares a parameter j in order to search the GW management table 530 for the GW information entry GEN with the GW apparatus ID 241 matching the GW apparatus ID on the received entry request. The search processing corresponds to S3503, S3507 and S3508.

In S3503, the integrated management 50 determines whether the GW apparatus ID 241 of the GW information entry GEN-j in the GW management table 530 matches the GW apparatus ID on the received entry request.

If the determination result in S3503 is YES (SQ1412, SQ1413 and SQ1414 in FIG. 14B correspond to this case), the integrated management 50, in S3504, determines whether the password 243 of the GW information entry GEN-j matches the password on the received entry request. S3503 and S3504 correspond to the GW validation SQ1414 in FIG. 14B.

If the determination result in S3504 is YES, the integrated management 50, in S3505, puts the return code indicating acceptance on the entry response.

In S3510, the integrated management 50 transmits the entry response containing the return code indicating acceptance to the INIT_Site 30, using the source IP address and the port number of the entry request as the destination information. SQ1415 in FIG. 14B corresponds to S3510.

If the determination result in S3504 is NO, the integrated management 50, in S3506, puts a return code indicating denial on the entry response.

In S3510, the integrated management 50 transmits the entry response containing the return code indicating denial to the INIT_Site 30, using the source IP address and the port number of the entry request as the destination information.

If the determination result in S3503 is NO, the integrated management 50 increments j to check the next GW information entry GEN in S3507.

In S3508, the integrated management 50 determines whether j is over the total number of the GW information entries of the GW management table 530.

If the determination result in S3508 is NO, the integrated management 50, in S3503, determines again whether the GW apparatus ID 241 of the GW information entry GEN-j matches the GW apparatus ID on the entry request.

If the determination result in S3508 is YES, the integrated management 50, in S3509, puts the return code indicating denial on the entry response.

In S3510, the integrated management 50 transmits the entry response containing the return code indicating denial to the INIT_Site 30, using the source IP address and the port number of the entry request as the destination information.

<SQ1416> Upon receipt of the entry response from the integrated management 50 in SQ1415, the INIT_Site 30 transfers the entry response to the GW 20.

The reception processing of the entry response by the INIT_Site 30 is described with reference to FIG. 30.

In S3001, the thread for communication processing with GW 330 of the INIT_Site 30 receives the entry response from the integrated management 50.

In S3002, the thread for communication processing with GW 330 of the INIT_Site 30 transfers the entry response to the GW 20 using the TLS connection taken from the INIT_Site main processing (FIG. 25). SQ1416 in FIG. 14B corresponds to S3002.

In S3003, the thread for communication processing with GW 330 of the INIT_Site 30 determines whether the return code on the entry response indicates acceptance.

If the determination result in S3003 is YES, the thread for communication processing with GW 330 of the INIT_Site 30 ends the entry response reception processing.

If the determination result in S3003 is NO, the opposite communication apparatus is not registered. Thus, in S3004, the thread for communication processing with GW 330 releases the TLS connection taken from the INIT_Site main processing (FIG. 25).

Then, in S3005, the thread for communication processing with GW 330 of the INIT_Site 30 disappears.

<SQ1417> Upon receipt of the entry response from the INIT_Site 30 in SQ1416, the GW 20 transmits a configuration acquisition request to the INIT_Site 30 for acquiring the information necessary for communication with the connected DCC_Site 40.

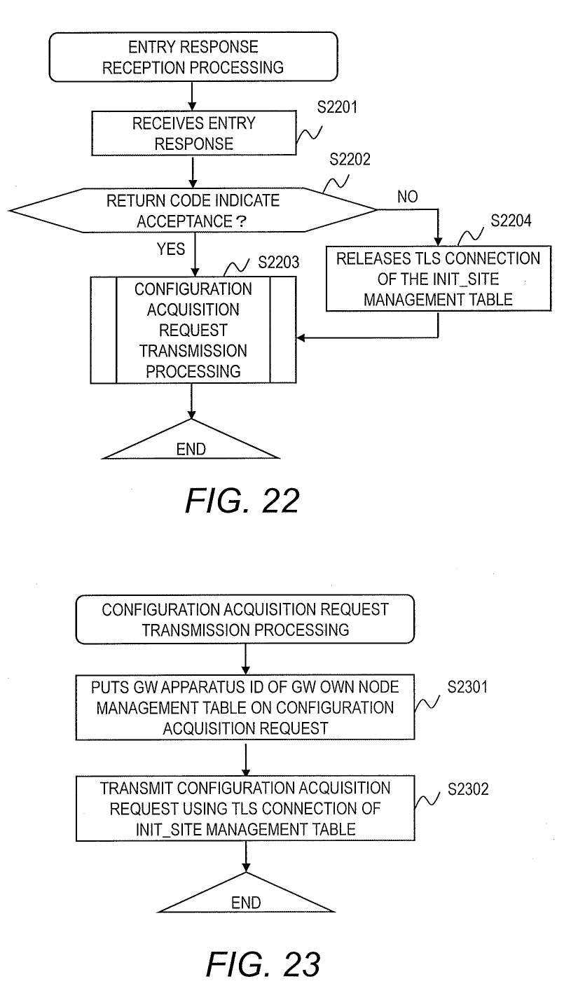

The reception processing of the entry response and the transmission processing of the configuration acquisition request by the GW 20 are described with reference to FIG. 22.

In S2201, the GW 20 receives the entry response from the INIT_Site 30.

In S2202, the GW 20 determines whether the return code on the entry response indicates acceptance.

If the determination result in S2202 is NO, the GW 20 releases the TLS connection 252 of the INIT_Site management table 250 in S2204.

If the determination result in S2202 is YES, the GW 20 can recognize that the GW 20 and the HES 60 are both apparatuses of the communication system, and thus the security is ensured. The TLS connection substantially guarantees that the communication opposite apparatus is not replaced during communication. The authentication code creation HMAC key 253 is a secret key and there is no other apparatus than the GW 20 and the integrated management 50 that has the substance of the key. Therefore, there is no other apparatus than the GW 20, the integrated management 50 and the INIT_Site 30 that can derive an execution result value (authentication code) of the HMAC function using the authentication code creation HMAC key 253 and the random number 254 as input information in terms of the characteristics of the HMAC function (the INIT_Site 30 transfers the execution result value). Thus, it precludes the possibility that an attacker masquerades as the INIT_Site 30 in the validation of the INIT_Site (SQ1408). In addition, there is no other apparatus than the GW 20, the integrated management 50 and the INIT_Site 30 that has the substance of the password 243 of the GW 20 (he INIT_Site 30 transfers the password 243). Thus, the integrated management 50 can determine that the GW 20 is an apparatus of the communication system in the GW validation (SQ1414).

If the determination result in S2202 is YES, the GW 20 can recognize that the GW 20 and the HES 60 are both apparatuses of the communication system, and thus the security is ensured. Thus, the GW 20 proceeds to S2203.

In S2203, the GW 20 performs the transmission processing of the configuration acquisition request.

The transmission processing of the configuration acquisition request in S2203 is described with reference to FIG. 23. The transmission processing of the configuration acquisition request is performed for the GW 20 to acquire information necessary for communication with the connected DCC_Site 40.

In S2301, the GW 20 puts the GW apparatus ID 241 described in the GW own node management table 240 on the configuration acquisition request.

In S2302, the GW 20 transmits the configuration acquisition request to the INIT_Site 30 using the TLS connection 252 of the INIT_Site management table 250. SQ1417 in FIG. 14B corresponds to S2302.

<SQ1418> Upon receipt of the configuration acquisition request from the GW 20, the INIT_Site 30 transfers the configuration acquisition request to the integrated management 50.

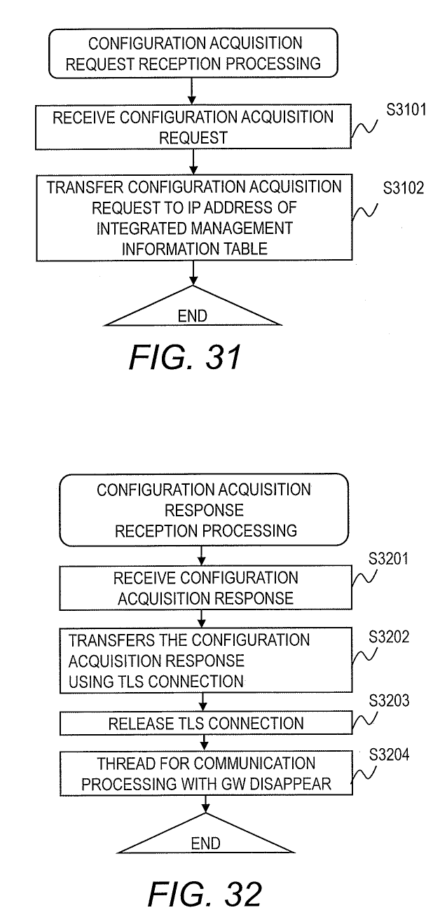

The reception processing of the configuration acquisition request by the INIT_Site 30 is described with reference to FIG. 31.

In S3101, the thread for communication processing with GW 330 of the INIT_Site 30 receives the configuration acquisition request from the GW 20.

In S3102, the thread for communication processing with GW 330 of the INIT_Site 30 transfers the configuration acquisition request to the integrated management 50 using the IP address 351 of the integrated management information table 350 as the destination information. SQ1418 in FIG. 14B corresponds to S3102.

<SQ1419> Upon receipt of the configuration acquisition request from the INIT_Site 30, the integrated management 50 creates information necessary for communication between the GW 20 and the DCC_Site 40.

<SQ1420> The integrated management 50 puts the WAN side IP address of the DCC_Site 40 connected with the GW 20, the IP address of the DCC_Site 40 in the IPsec tunnel, the IP address of the GW 20 in the IPsec tunnel and the IKE pre-shared key necessary for the IKE pre-shared key authentication between the GW 20 and the DCC_Site 40 on the configuration acquisition response, and transmits it to the INIT_Site 30.

<SQ1421> The integrated management 50 puts the IP address of the GW 20 in the IPsec tunnel as the IKE initiator ID of the GW 20 and the IKE pre-shared key paired with the IKE initiator ID on a configuration information notice, and transmits it to the DCC_Site 40. The IKE pre-shared key is the same as the IKE pre-shared key on the configuration acquisition response in SQ1420.

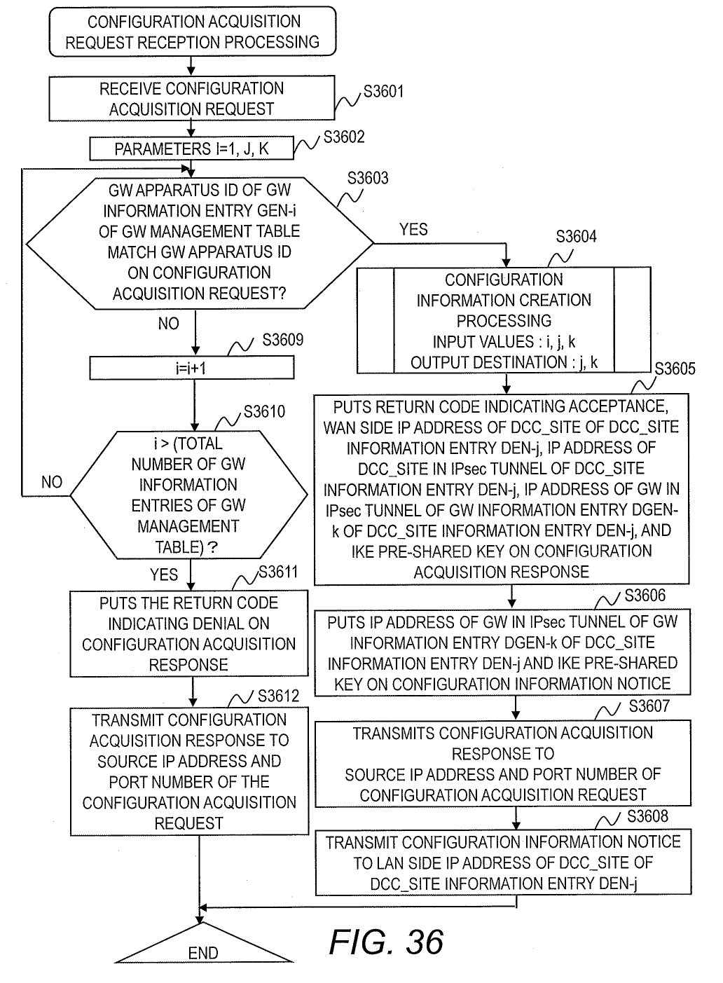

The reception processing of the configuration acquisition request, the configuration information creation processing and the transmission processing of the configuration acquisition response by the integrated management 50 are described with reference to FIG. 36.

In S3601, the integrated management 50 receives the configuration acquisition request from the INIT_Site 30.

In S3602, the integrated management 50 prepares parameters i, j and k. The parameter j is used for searching for the GW information entry GEN including the GW apparatus ID 241 matching the GW apparatus ID on the received configuration acquisition request. The parameter k is used for referring to the DCC_Site information entry DEN including the information on the DCC_Site 40 to be connected with the GW 20. The parameter k is used for referring to the GW information entry DGEN including the information necessary for communication between the GW 20 and the DCC_Site 40-j existing in the DCC_Site information entry DEN-j.

In S3603, the integrated management 50 determines whether the GW apparatus ID 241 of the GW information entry GEN-i of the GW management table 530 matches the GW apparatus ID on the configuration acquisition request.

If the determination result in S3603 is YES, the integrated management 50 performs the configuration information creation processing using i, j and k as input values in S3604. SQ1419 in FIG. 14B corresponds to S3604. The configuration information creation processing S3604 obtains output values from the information of the GW information entry GEN-i of the GW management table 530 and puts the output values into j and k. At this point, j indicates the number of the DCC_Site information entry DEN containing the information on the DCC_Site 40 connected with the GW 20. At this point, k indicates the number of the GW information entry DGEN existing in the DCC_Site information entry DEN-j and containing the information necessary for communication between the GW 20 and the DCC_Site 40.

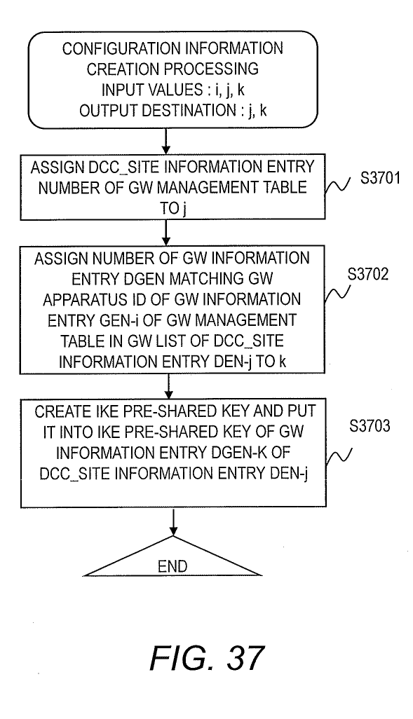

The configuration information creation processing in S3604 is described with reference to FIG. 37.

In S3701, the integrated management 50 assigns the DCC_Site information entry number 531 of the GW management table 530 to j. Thus, the DCC_Site 40-j associated with the DCC_Site information entry DEN-j is the connection destination of the GW 20.

In S3702, the integrated management 50 assigns the number of the GW information entry DGEN matching the GW apparatus ID 241 of the GW information entry GEN-i of the GW management table 530 in the GW list 523 of the DCC_Site information entry DEN-j to k.

In S3703, the integrated management 50 creates the IKE pre-shared key and puts it into the IKE pre-shared key 525 of the GW information entry DGEN-k of the DCC_Site information entry DEN-j. Then, the integrated management 50 ends the configuration information creation processing.

Returning to the flow of FIG. 36, the integrated management 50, in S3605, puts a return code indicating acceptance, the WAN side IP address of the DCC_Site 431 of the DCC_Site information entry DEN-j, the IP address of the DCC_Site in the IPsec tunnel 432 of the DCC_Site information entry DEN j, the IP address of the GW in the IPsec tunnel 524 of the GW information entry DGEN-k of the DCC_Site information entry DEN-j, and the IKE pre-shared key 525 on the configuration acquisition response.

In S3606, the integrated management 50 puts the IP address of the GW in the IPsec tunnel 524 of the GW information entry DGEN-k of the DCC_Site information entry DEN-j and the IKE pre-shared key 525 on the configuration information notice.

In S3607, the integrated management 50 transmits the configuration acquisition response created in S3605 to the INIT_Site 30 using the source IP address and the port number of the configuration acquisition request as the destination information. SQ1420 in FIG. 14B corresponds to S3607.

In S3608, the integrated management 50 transmits the configuration information notice created in S3606 to the DCC_Site 40 using the LAN side IP address of the DCC_Site 522 of the DCC_Site information entry DEN-j as the destination information. SQ1421 in FIG. 14B corresponds to S3608.

If the determination result in S3603 is NO, the integrated management 50 increments i to check the next GW information entry GEN in S3609.

In S3610, the integrated management 50 determines whether i is over the total number of the GW information entries of the GW management table 530.

If the determination result in S3610 is NO, the integrated management 50 determines again whether the GW apparatus ID 241 of the GW information entry GEN-i of the GW management table 530 matches the GW apparatus ID on the configuration acquisition request in S3603.

If the determination result in S3610 is YES, the integrated management 50 puts the return code indicating denial on the configuration acquisition response.

In S3612, the integrated management 50 transmits the configuration acquisition response created in S3611 to the DCC_Site 40 using the source IP address and the port number of the configuration acquisition request as the destination information.

<SQ1422> Upon receipt of the configuration acquisition response from the integrated management 50 in SQ1420, the INIT_Site 30 transfers the configuration acquisition response to the GW 20.

The reception processing of the configuration acquisition response by the INIT_Site 30 is descried with reference to FIG. 32.

In S3201, the thread for communication processing with GW 330 of the INIT_Site 30 receives the configuration acquisition response from the integrated management 50.

In S3202, the thread for communication processing with GW 330 of the INIT_Site 30 transfers the configuration acquisition response to the GW 20 using the TLS connection taken from the INIT_Site main processing (FIG. 25). SQ1422 in FIG. 14B corresponds to S3202.

With the above, the thread for communication processing with GW 330 of the INIT_Site 30 has completed the procedure with the GW 20 and thus releases the TLS connection taken from the INIT_Site main processing (FIG. 25).

In S3204, the thread for communication processing with GW 330 of the INIT_Site 30 disappears.

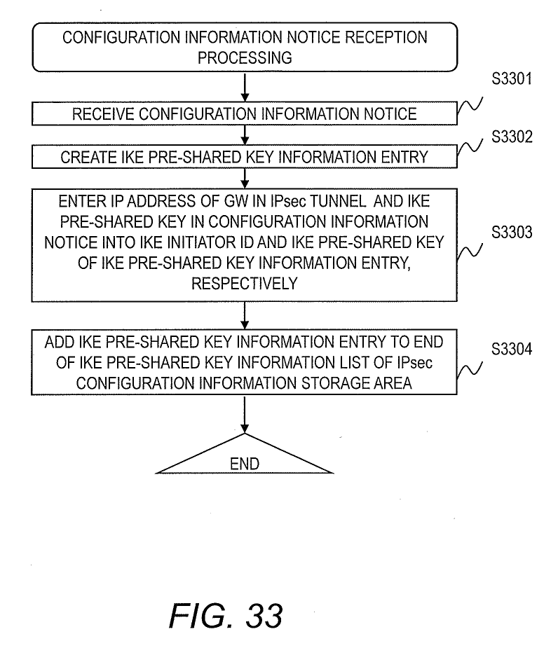

The reception processing of the configuration information notice by the DCC_Site 40 is described with reference to FIG. 33.

In S3301, the DCC_Site 40 receives the configuration information notice from the integrated management 50.

In S3302, the DCC_Site 40 creates an IKE pre-shared key information entry IEN.

In S3303, the DCC_Site 40 enters the IP address of the GW in the IPsec tunnel in the configuration information notice into the IKE initiator ID 263 of the IKE pre-shared key information entry IEN created in S3302. The DCC_Site 40 enters the IKE pre-shared key of the configuration information notice into the IKE pre-shared key 525 of the IKE pre-shared key information entry IEN.

In S3304, the DCC_Site 40 adds the IKE pre-shared key information entry IEN to the end of the IKE pre-shared key information list 435 of the IPsec configuration information storage area 430.

<SQ1423> Upon receipt of the configuration acquisition response from the INIT_Site 30 in SQ1422, the GW 20 provides the information contained in the configuration acquisition response to the IPsec communication preprocessing unit 230, the IPsec communication preprocessing unit 230 establishes an IPsec cryptographic communication channel with the DCC_Site 40 by IKE negotiation with the DCC_Site 40.

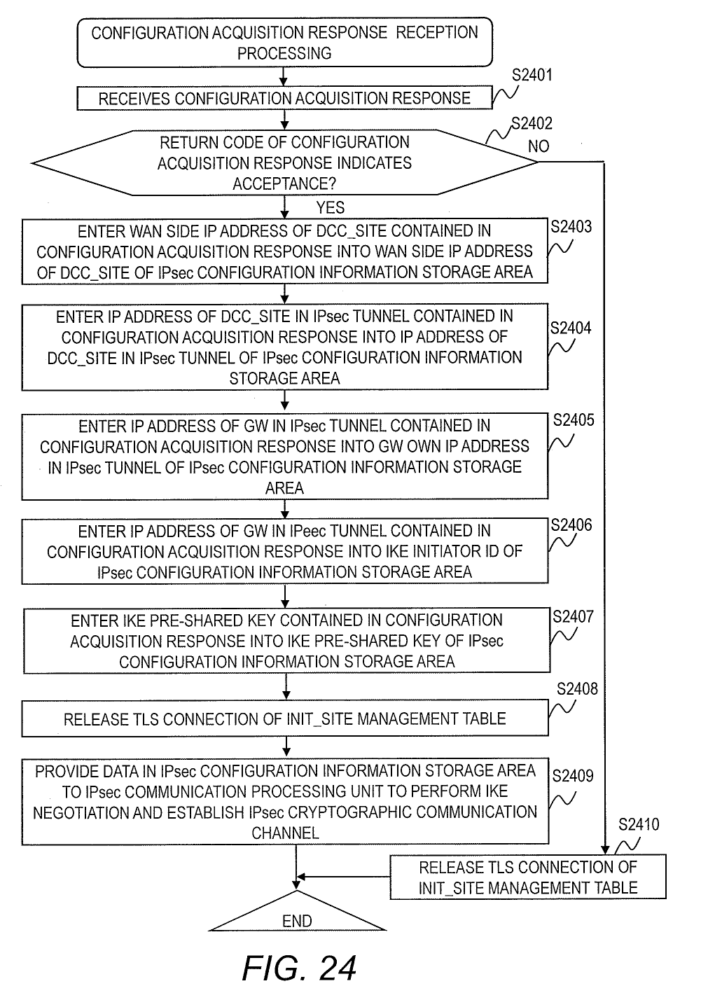

The reception processing of the configuration acquisition response by the GW 20 is described with reference to FIG. 24.

In S2401, the GW 20 receives the configuration acquisition response from the INIT_Site 30.

In S2402, the GW 20 determines whether the return code of the configuration acquisition response indicates acceptance.

If the return code indicates acceptance, in short, the determination result in S2402 is YES, the GW 20 enters the WAN side IP address of the DCC_Site contained in the configuration acquisition response into the WAN side IP address of the DCC_Site 431 of the IPsec configuration information storage area 260.

In S2404, the GW 20 enters the IP address of the DCC_Site in the IPsec tunnel contained in the configuration acquisition response into the IP address of the DCC_Site in the IPsec tunnel 432 of the IPsec configuration information storage area 260.

In S2405, the GW 20 enters the IP address of the GW in the IPsec tunnel contained in the received configuration acquisition response into the GW own IP address in the IPsec tunnel 262 of the IPsec configuration information storage area 260.

In S2406, the GW 20 enters the IP address of the GW in the IPsec tunnel contained in the received configuration acquisition response into the IKE initiator ID 263 of the IPsec configuration information storage area 260.

In S2407, the GW 20 enters the IKE pre-shared key contained in the received configuration acquisition response into the IKE pre-shared key 525 of the IPsec configuration information storage area 260.

With the above, the GW 20 has completed the procedure with the INIT_Site 30 and thus releases the TLS connection 252 of the INIT_Site management table 250 in S2408.

In S2409, the GW 20 provides the data in the IPsec configuration information storage area 260 to the IPsec communication processing unit 230. The IPsec communication processing unit 230 negotiates with the DCC_Site 40 and establishes an IPsec cryptographic communication channel with the DCC_Site 40. SQ1423 in FIG. 14B corresponds to S2409.

If the return code indicates denial, in short, the determination result in S2402 is NO, the GW 20 releases the TLS connection 252 of the INIT_Site management table 250 and ends the reception processing of the configuration acquisition response.

As described above, the communication system according to the embodiment includes the GW, which is a client in the TLS negotiation, the INIT_Site, which is a server in the TLS negotiation, the integrated management, which is a server managing the entire system behind the INIT_Site, and the DCC_Site, which is a server to communicate directly with the GW for a long time and receive user data from the GW. The INIT_Site, the DCC_Site and the integrated management constitute a subsystem of the communication system. The subsystem referred as HES.

The GW 20 establishes a TLS cryptographic communication channel between the GW and the INIT_Site in TLS negotiation without verification of an X.509 server certificate transmitted from the INIT_Site. Subsequently, the GW 20 confirms that the INIT_Site is an apparatus of the communication system by checking the authentication information transmitted from the INIT_Site. Then, the GW 20 acquires the X.509 server certificate of the INIT_Site from the INIT_Site and installs it. Next, the GW transmits authentication information to the INIT_Site and the INIT_Site transfers the authentication information to the integrated management so that the integrated management recognizes the GW as an apparatus of the communication system.

As described above, both the GW and the HES acknowledge that the other is an apparatus of the communication system and then the integrated management creates the IKE pre-shared key. The integrated management transmits the IKE pre-shared key to the INIT_Site and the DCC_Site. The INIT_Site transfers the IKE pre-shared key to the GW. Thus, the IKE pre-shared key are shared between the GW and the DCC_Site, and an IPsec cryptographic communication channel can be established between the GW and the DCC_Site.

With the above, the pre-installation of the X.509 server certificate and the IKE pre-shared key before factory shipment can be avoided.

Although the present disclosure has been described with reference to exemplary embodiments, those skilled in the art will recognize that various changes and modifications may be made in form and detail without departing from the spirit and scope of the claimed subject matter.

The present invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD, or a storage medium such as an IC card, or an SD card.

The drawings shows control lines and information lines as considered necessary for explanations but do not show all control lines or information lines in the products. It can be considered that almost of all components are actually interconnected.

What is claimed is:

1. An information collection system comprising:
an information processing system; and
a gateway connected with the information processing system via a network,
wherein the information processing system includes:
a first server being an initial connection destination of the gateway;
a second sever being a transmission destination of measured data from the gateway; and
a third server managing the first server and the second server,
wherein the gateway is configured to hold:
gateway information managing an identifier of the gateway and apparatus specific information of the gateway;
first server connection destination information; and
first server management information managing a created random number and a common key outputted in accordance with a common rule,
wherein the first server is configured to hold a server certificate,
wherein the third server is configured to hold gateway management information including, for each gateway, apparatus specific information, an identifier and a common key outputted in accordance with a common rule,
wherein the gateway is configured to transmit a server authentication request including the created random number and the identifier of the gateway to the first server,
wherein the third server is configured to:
receive the server authentication request transferred from the first server and create a first authentication code based on the random number contained in the server authentication request and a common key associated with the gateway in the gateway information; and
transmit a server authentication response containing first authentication code to the first server, and
wherein the gateway is configured to:
receive the server authentication response transferred from the first server and create a second authentication code based on the created random number and the common key in the first server management information;
make first determination whether the second authentication code matches the first authentication code contained in the server authentication response; and
acquire the server certificate from the first server and store the server certificate in the first server management information when the second authentication code matches the first authentication code contained in the server authentication response in the first determination.

2. The information collection system according to claim 1,
wherein the gateway and the third server each configured to hold the common rule in advance,
wherein the gateway, after activation, is configured to store the common key created based on the common rule and the apparatus specific information in the gateway information in the first server management information, and
wherein the third server, after activation of the gateway, is configured to create the common key based on the common rule and the apparatus specific information of the gateway contained in the gateway management information, and store the created common key in the gateway management information.

3. The information collection system according to claim 2,
wherein the apparatus specific information is a MAC address, and
wherein the common key is an HMAC key.

4. The information collection system according to claim 2,
wherein, the gateway is configured to:
refer to the first server connection destination information and connect to the first server before transmitting the server authentication request;
maintain connection between the gateway and the first server when the second authentication code matches the first authentication code in the first determination; and
release the connection between the gateway and the first server when the second authentication code does not match the first authentication code in the first determination.

5. The information collection system according to claim 2,
wherein the third server is configured to:
receive the server authentication request transferred from the first server and make a second determination whether the identifier contained in the server authentication request matches an identifier in the gateway management information;
create the first authentication code when the identifier contained in the server authentication request matches an identifier in the gateway management information in the second determination; and
skip creating the first authentication code when the identifier contained in the server authentication request does not match any identifier in the gateway management information in the second determination.

6. The information collection system according to claim 1, further comprising a sensor node transmitting the measured data to the gateway.

7. The information collection system according to claim 2,
wherein the gateway information includes a password created in accordance with a common rule,
wherein the gateway is configured to transmit an entry request containing the password and the identifier of the gateway to the first server after storing the server certificate,
wherein the gateway management information of the third server includes a password created in accordance with a common rule for each gateway,
wherein the third server is configured to:
receive the entry request transferred from the first server and make a third determination whether the password contained in the entry request matches the password for the gateway in the gateway management information;
permit the gateway to enter the information processing system when the password contained in the entry request matches the password for the gateway in the gateway management information in the third determination; and
prohibit the gateway from entering the information processing system when the password contained in the entry request does not match the password for the gateway in the gateway management information in the third determination.

8. The information collection system according to claim 7,
wherein the gateway, after activation, is configured to create the password based on the common rule and the apparatus specific information of the gateway in the gateway information, and store the password in the gateway information, and
wherein, after the gateway is activated, the third server is configured to create the password based on the common rule and the apparatus specific information of the gateway in the gateway management information, and store the password in the gateway management information.

9. The information collection system according to claim 8,
wherein the third server is configured to:
make a fourth determination whether the identifier of the gateway contained in the entry request matches an identifier in the gateway management information;
make the third determination when the identifier of the gateway contained in the entry request matches an identifier in the gateway management information in the fourth determination; and
skip making the third determination when the identifier of the gateway contained in the entry request does not match any identifier in the gateway management information in the fourth determination.

10. The information collection system according to claim 8,
wherein the third server is configured to transmit an entry response indicating permission to the first server when permitting the gateway to enter the information processing system,
wherein the gateway is configured to receive the entry response indicating permission transferred from the first server and transmit to the first server a configuration acquisition request for acquiring configuration information including connection information with the second server,
wherein the third server is configured to:
receive the configuration acquisition request transferred from the first server;
make a fifth determination whether the identifier of the gateway contained in the configuration acquisition request matches an identifier in the gateway management information;
skip creating the configuration information when the identifier of the gateway contained in the configuration acquisition request does not match any identifier in the gateway management information in the fifth determination;
when the identifier of the gateway contained in the configuration acquisition request matches an identifier in the gateway management information in the fifth determination,
transmit a configuration acquisition response containing first configuration information including a created pre-shared key and second server connection destination information to the first server, and
transmit a configuration information notice containing second configuration information including a created pre-shared key and gateway connection source information to the second server,
wherein the second server is configured to hold the second configuration information contained in the configuration information notice, and
wherein the gateway is configured to:
hold the first configuration information contained in the configuration acquisition response transferred from the first server; and
refer to second server connection destination information in the first configuration information and connect to the second server using the pre-shared key in the first configuration information.

11. A connection control method in an information collection system including an information processing system and a gateway connected with the information processing system via a network,
the information processing system including:
a first server being an initial connection destination of the gateway and holding a sever certificate;
a second sever being a transmission destination of measured data from the gateway; and
a third server managing the first server and the second server,
the gateway holding:
gateway information managing an identifier of the gateway and apparatus specific information of the gateway;
first server connection destination information; and
first server management information including managing a created random number and a common key outputted in accordance with a common rule,
the third server holding gateway management information including, for each gateway, apparatus specific information, an identifier and a common key outputted in accordance with a common rule,
the connection control method comprising:
transmitting, by the gateway, a server authentication request including the created random number and the identifier of the gateway to the first server,
receiving, by the third server, the server authentication request transferred from the first server and creating a first authentication code based on the random number contained in the server authentication request and a common key associated with the gateway in the gateway information;
transmitting, by the third server, a server authentication response containing first authentication code to the first server;
receiving, by the gateway, the server authentication response transferred from the first server and creating a second authentication code based on the created random number and the common key in the first server management information;
making, by the gateway, first determination whether the second authentication code matches the first authentication code contained in the server authentication response; and
acquiring, by the gateway, the server certificate from the first server and storing the server certificate in the first server management information when the second authentication code matches the first authentication code contained in the server authentication response in the first determination.

12. The connection control method according to claim 11,
wherein the gateway information includes a password created in accordance with a common rule,
wherein the gateway management information includes a password created in accordance with a common rule for each gateway, and
wherein the connection control method further comprising:
transmitting, by the gateway, an entry request containing the password and the identifier of the gateway to the first server after storing the server certificate,
receiving, by the third server, the entry request transferred from the first server and making a third determination whether the password contained in the entry request matches the password for the gateway in the gateway management information;
permitting, by the third server, the gateway to enter the information processing system when the password contained in the entry request matches the password for the gateway in the gateway management information in the third determination; and
prohibiting, by the third server, the gateway from entering the information processing system when the password contained in the entry request does not match the password for the gateway in the gateway management information in the third determination.

13. The connection control method according to claim 12 further comprising:
transmitting, by the third server, an entry response indicating permission to the first server when permitting the gateway to enter the information processing system;
receiving, by the gateway, the entry response indicating permission transferred from the first server and transmitting to the first server a configuration acquisition request for acquiring configuration information including connection information with the second server;
receiving, by the third server, the configuration acquisition request transferred from the first server;
making, by the third server, a fifth determination whether the identifier of the gateway contained in the configuration acquisition request matches an identifier in the gateway management information;
skipping, by the third server, creating the configuration information when the identifier of the gateway contained in the configuration acquisition request does not match any identifier in the gateway management information in the fifth determination;
transmitting, by the third server, the a configuration acquisition response containing first configuration information including a created pre-shared key and second server connection destination information to the first server and transmitting a configuration information notice containing second configuration information including a created pre-shared key and gateway connection source information to the second server when the identifier of the gateway contained in the configuration acquisition request matches an identifier in the gateway management information in the fifth determination;
holding, by the second server, the second configuration information contained in the configuration information notice;
holding, by the gateway, the first configuration information contained in the configuration acquisition response transferred from the first server; and
referring, by the gateway, to second server connection destination information in the first configuration information and connecting to the second server using the pre-shared key in the first configuration information.
